(19) United States
(12) Patent Application Publication
(10) Pub. No.: US 2025/0150595 A1
(43) Pub. Date: May 8, 2025

(54) Apparatuses and Methods for Encoding or Decoding a Picture of a Video

(71) Applicant: Fraunhofer-Gesellschaft zur Förderung der angewandten Forschung e.V., München (DE)

(72) Inventors: Michael SCHÄFER, Berlin (DE); Sophie PIENTKA, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/016,172

(22) Filed: Jan. 10, 2025

Related U.S. Application Data
(63) Continuation of application No. PCT/EP2023/069557, filed on Jul. 13, 2023.

(30) Foreign Application Priority Data
Jul. 14, 2022 (EP) 22185044.9

(51) Int. Cl. H04N 19/137; H04N 19/105; H04N 19/172

(52) U.S. Cl. CPC H04N 19/137; H04N 19/105; H04N 19/172

(57) ABSTRACT

A coding concept for encoding and decoding a picture is described, according to which a machine learning predictor is used to derive a set of features representing a motion estimation for the picture with respect to a previous picture. The set of features, as well as a residual picture derived using the motion estimation, are encoded into a data stream.

### CROSS-REFERENCES TO RELATED APPLICATIONS

This application is a continuation of copending International Application No. PCT/EP2023/069557, filed Jul. 13, 2023, which is incorporated herein by reference in its entirety, and additionally claims priority from European Application No. EP 22 185 044.9, filed Jul. 14, 2022, which is incorporated herein by reference in its entirety.

Embodiments of the present invention relate to an apparatus and a method for encoding a picture, e.g. of a video, an apparatus and a method for decoding a picture, e.g. of a video, and a data stream comprising an encoded picture, e.g. of video. Some embodiments relate to motion estimation via an auto encoder. Some embodiments relate to deep video coding with gradient-descent optimized motion compensation and/or Lanczos filtering.

### BACKGROUND OF THE INVENTION

With the rise of streaming services in the last decade, videos continue to be the most important share of the internet traffic. As transmission capabilities are limited, research focuses on finding efficient compression for a given bit budget. Traditional video codecs such as Versatile Video Coding (VVC) [4], [5], [6] use a hybrid, block-based approach, which relies on hand-crafted modules. One of the most important aspects of video coding is motion-compensated prediction which, in contrast to image compression, exploits temporal redundancies between different frames. Here, displacements of the reconstructed samples of already decoded frames serve as a prediction for the samples of the current frame. The displacement information as well as the prediction residual are coded in the bitstream.

Inter-prediction methods are still an integral part of state-of-the-art video codecs such as VVC, as shown in [11]. VVC also utilizes more complex interpolation than previous video coding standards. It uses 1/16 sample positions for subblock-based motion derivation and interpolation filters with 8-tap filters for luma inputs. Those interpolation methods can also be implemented with data driven methods. Liu et al. show in [14] that convolutional neural networks can replace handcrafted interpolation filters.

In the field of image compression, there has been a lot of success with end-to-end autoencoder approaches [1, 15]. These systems try to find a representation of the input image as features in the latent space typically by employing convolutional neural networks (CNNs). These features are then quantized and transmitted with entropy coding. Ballé et al. [8] introduced hyper priors, which use a second autoencoder to estimate and transmit the parameters of the unknown underlying distribution of the features. These networks are usually optimized with respect to the sum of a distortion measure D and an estimation of the rate R with the Lagrange parameter λ>0, i.e D+λR, which is also called R-D cost.

In the last years, there has been some promising work to apply these methods to video coding. In [2], Lu et al. proposed deep video compression (DVC), the first end-to-end neural network based video compression framework with a pre-trained CNN-based model for motion estimation and two autoencoders for motion compression and residual coding, which are all trained jointly. The framework operates in a low latency setting, where the first frame is coded as an I-frame and all consecutive frames are coded as P-frames, which can access information from the previous frame. In [7], Agutsson et al. trained an end-to-end, low-latency video compression framework, which uses 3 jointly trained auto-encoders. The authors use an autoencoder to simultaneously estimate and compress the motion field. They also introduced a generalized version of optical flow and bilinear warp to better handle failure cases such as disocclusions or fast motion.

There also have been advances in using deep-learned bi-directional video compression as in [19, 18]. Yilmaz et al. use subsampling to further optimize the motion field with respect to the R-D cost. This method ensures that the learned weights are more generalized and less dependent on the training data.

Still, there is an ongoing desire to improve video compression, e.g. in terms of a rate-distortion relation, computational effort, and/or complexity.

Accordingly, an object of the present invention is to provide a concept for encoding a picture of a video into a data stream and for decoding a picture of a video from the data stream, which concept provides an improved tradeoff between rate-distortion relation, computational effort, complexity, and hardware requirements such as buffer requirements.

### SUMMARY

An embodiment may have an apparatus for encoding a picture of a video into a data stream, configured for using a first machine learning predictor to derive a set of features representing a motion estimation for the picture with respect to a previous picture of the video, encoding the set of features into the data stream, predicting the picture using the set of features to derive a residual picture by determining a set of reconstructed motion vectors based on the features, deriving a motion-predicted picture based on a reconstructed previous picture using the set of reconstructed motion vectors, and deriving the residual picture based on the picture and the motion-predicted picture, and encoding the residual picture into the data stream, wherein the reconstructed motion vectors represent vectors in a motion space, the motion space being defined by a plurality of pictures comprising the previous picture and a set of filtered versions of the previous picture.

Another embodiment may have an apparatus for encoding a picture of a video into a data stream, configured for using a first machine learning predictor to derive a set of features representing a motion estimation for the picture with respect to a previous picture of the video, encoding the set of features into the data stream, predicting the picture using the set of features to derive a residual picture, by using a second machine learning predictor to determine a set of reconstructed motion vectors based on the features, deriving a motion-predicted picture based on the previous picture using the set of reconstructed motion vectors, and deriving the residual picture based on the motion-predicted picture and the picture, and encoding the residual picture into the data stream, wherein the apparatus is configured for optimizing the features with respect to a rate-distortion measure for the features, the rate-distortion measure being determined based on a distortion between the picture and the motion-predicted picture.

Another embodiment may have an apparatus for decoding a picture of a video from a data stream, configured for decoding a set of features from the data stream, the set of features representing a motion estimation for the picture with respect to a previous picture of the video, decoding a residual picture from the data stream, and using a machine learning predictor to determine a set of reconstructed motion vectors based on the features, and reconstructing the picture based on the residual picture using the set of reconstructed motion vectors, wherein the reconstructed motion vectors represent vectors in a motion space, the motion space being defined by a plurality of pictures comprising the previous picture and a set of filtered versions of the previous picture.

Another embodiment may have a method for encoding a picture of a video into a data stream, comprising: using a first machine learning predictor to derive a set of features representing a motion estimation for the picture with respect to a previous picture of the video, encoding the set of features into the data stream, predicting the picture using the set of features to derive a residual picture by determining a set of reconstructed motion vectors based on the features, deriving a motion-predicted picture based on a reconstructed previous picture using the set of reconstructed motion vectors, and deriving the residual picture based on the picture and the motion-predicted picture, and encoding the residual picture into the data stream, wherein the reconstructed motion vectors represent vectors in a motion space, the motion space being defined by a plurality of pictures comprising the previous picture and a set of filtered versions of the previous picture.

Another embodiment may have a method for encoding a picture of a video into a data stream, the method comprising: using a first machine learning predictor to derive a set of features representing a motion estimation for the picture with respect to a previous picture of the video, encoding the set of features into the data stream, predicting the picture using the set of features to derive a residual picture, by using a second machine learning predictor to determine a set of reconstructed motion vectors based on the features, deriving a motion-predicted picture based on the previous picture using the set of reconstructed motion vectors, and deriving the residual picture based on the motion-predicted picture and the picture, and encoding the residual picture into the data stream, wherein the method comprise optimizing the features with respect to a rate-distortion measure for the features, the rate-distortion measure being determined based on a distortion between the picture and the motion-predicted picture.

Another embodiment may have a method for decoding a picture of a video from a data stream, comprising: decoding a set of features from the data stream, the features representing a motion estimation for the picture with respect to a previous picture of the video, decoding a residual picture from the data stream, and using a machine learning predictor to determine a set of reconstructed motion vectors based on the features, and reconstructing the picture based on the residual picture using the set of reconstructed motion vectors, wherein the reconstructed motion vectors represent vectors in a motion space, the motion space being defined by a plurality of pictures comprising the previous picture and a set of filtered versions of the previous picture.

Embodiments of the present invention rely on the idea, to use a machine learning predictor to derive a motion-estimation for the currently coded picture with respect to a previous picture of the video. The motion-estimation is used for predicting the picture to derive a residual picture. As the residual is probably small, it may be efficiently encoded, i.e. it may requires a low bitrate. The inventors found that using a machine learning predictor, e.g. a dedicated machine learning predictor, for deriving the motion compensation provides for a high compression efficiency. In particular, embodiments of the invention rely on the idea to use the machine learning predictor to determine a set of features representing the motion estimation, and to transmit the set of features in the data stream. The inventors realized that the increase in compression efficiency provided by the motion prediction overcompensates the additional bitrate required for the transmission of the features representing the motion estimation.

Embodiments of the present invention provide an apparatus for encoding a picture (e.g., referred to as the current picture) of a video into a data stream, configured for using a machine learning predictor (e.g. a first machine learning predictor, e.g., a first neural network) to derive a set of features representing a motion estimation for the picture with respect to a previous picture of the video; encoding the set of features into the data stream; predicting the picture using the set of features to derive a residual picture (e.g. using the features for obtaining a (motion compensated) reference picture based on a previous picture of the video; and deriving a residual picture based on the picture and the reference picture); and encoding the residual picture into the data stream.

According to embodiments, the residual picture is derived based on the picture and a motion-predicted picture, which is derived using a set of reconstructed motion vectors. The motion vectors are derived from the features representing the motion-estimation. In particular, the reconstructed motion vectors may represent vectors of a motion space being defined by a plurality of pictures comprising the previous picture and a set of filtered versions of the previous picture (e.g. blurred versions, filtered by convolution with respective Gaussian kernels) (and, e.g., wherein the motion space is spanned in a first dimension and a second dimension by first and second dimensions of 2D sample arrays of the pictures, and in a third dimension by an order among the plurality of pictures). The apparatus may derive a sample of the motion-predicted picture by weighting a set of samples of the motion space, the samples of the set of samples being positioned within a region of the motion space (e.g., a 3D region), which region is indicated by the corresponding reconstructed motion vector of the sample of the motion-predicted picture. In particular, the apparatus may weight the samples of the set of samples using one or more Lanczos filters to derive the sample. In examples, the region extends beyond direct neighbors of the sample.

The inventors realized that Lanczos filters may provide a more accurate interpolation of samples of the motion space, e.g. compared to bilinear interpolation, and in particular, that the additional computational effort that might be caused by evaluating the Lanczos filter may be overcompensated by a particular high increase in compression rate, which is caused by the increased accuracy of the motion-predicted picture.

According to an embodiment, the apparatus derives a set of motion vectors based on the picture and the previous picture (e.g., based on a reconstructed version thereof, which is obtained from the previous picture) using a motion estimation network, the motion estimation network comprising a machine learning predictor (e.g., a neural network, e.g. a further machine learning predictor to the first machine learning predictor). According to this embodiment, the first machine learning predictor is configured for deriving the features based on the set of motion vectors.

The determination of motion vectors, and using these motion vectors for the determination of the features by the first machine learning predictor, e.g. as an input thereof, may provide an improved initialization of the first machine learning predictor, and may therefore improve the set of feature, e.g. in their accuracy of representing the motion-estimation.

According to an embodiment, the apparatus is configured for optimizing the features with respect to a rate-distortion measure for the features, the rate-distortion measure being determined based on a distortion between the picture and the motion-predicted picture (e.g. a norm of the residual picture, e.g. a sum of absolutes of sample values of the residual picture). The motion-predicted picture may be derived based on the previous picture using a set of reconstructed motion vectors, which is determined based on the features using a second machine learning predictor. For example, the distortion between the picture and the motion-predicted picture may be used to determine or to estimate a rate for encoding a residuum between the picture and the motion-predicted picture, e.g. referred to as residual picture.

The inventor realized that the effort of performing a rate-distortion optimization of the set of features is overcompensated by the achieved improvements in terms of a rate-distortion measure. Furthermore, the rate-distortion may improve independency from the training data set using which the first machine learning predictor was trained.

According to an embodiment, the apparatus is configured for optimizing the features using a gradient descent algorithm (e.g. back tracking line search algorithm, or any other gradient descent algorithm) with respect to the rate-distortion measure. The inventors found that a gradient descent algorithm, when applied to the set of features, provides a good tradeoff between effort, complexity and rate-distortion improvement.

According to an embodiment, the apparatus is configured for determining a rate measure for the rate-distortion measure based on the residual picture using a spatial-to-spectral transformation. In particular, in examples, in which transform coding is used for encoding the residual picture into the data stream, the transformed residual picture may provide an accurate measure for the rate involved with the encoding of the residual picture.

According to an embodiment, the apparatus is configured for determining the distortion between the picture and the motion-predicted picture based on the residual picture using a spatial-to-spectral transformation. In other words, for determining the rate-distortion measure, with respect to which the features are optimized, the apparatus may use a residual picture derived from the features, for which the rate-distortion measure is to be determined. The residual picture may be determined by reconstructing motion vectors based on the features, determining a motion-predicted picture based on the reconstructed motion vectors, and forming a residuum between the original picture and the predicted picture. For determining the distortion, the apparatus may, for example, subject the residual picture to the spectral-to-spatial transform, e.g., in units of blocks, and the apparatus may determine the distortion, e.g., by applying a norm to the residual picture. In other words, the distortion between the picture and the motion-predicted picture may be a measure for the residuum between the picture and the motion-predicted picture, and the distortion may serve as an estimate for the rate for encoding the residual picture, when derived based on the set of features, for which the rate-distortion measure is to be determined. In particular, a small distortion may correlate with a small rate of the residuum.

Further embodiments of the invention provide an apparatus for decoding a picture of a video from a data stream, configured for decoding a set of features (e.g. quantized features) from the data stream, the set of features representing a motion estimation for the picture with respect to a previous picture of the video; decoding a residual picture from the data stream; and using a machine learning predictor (e.g. a second machine learning predictor, e.g. a neural network, e.g. an upsampling convolutional neural network) to reconstruct the picture based on the residual picture using the set of features.

Further embodiments of the invention provide a method for encoding a picture (e.g., referred to as the current picture) of a video into a data stream, the method comprising: using a machine learning predictor (e.g. a first machine learning predictor, e.g. a first neural network) to derive a set of features representing a motion estimation for the picture with respect to a previous picture of the video; encoding the set of features into the data stream; predicting the picture using the set of features to derive a residual picture (e.g. using the features for obtaining a (motion compensated) reference picture based on a previous picture of the video; and deriving a residual picture based on the picture and the reference picture); and encoding the residual picture into the data stream.

Further embodiments of the invention provide a method for decoding a picture of a video from a data stream, the method comprising: decoding a set of features (e.g. quantized features) from the data stream, the features representing a motion estimation for the picture with respect to a previous picture of the video; decoding a residual picture from the data stream; and using a machine learning predictor (e.g. a second machine learning predictor, e.g. a neural network) to reconstruct the picture based on the residual picture using the set of features.

### BRIEF DESCRIPTION OF THE DRAWINGS

Embodiments of the present invention will be detailed subsequently referring to the appended drawings, in which:

FIG. 1 illustrates an example of an encoder,

FIG. 2 illustrated an example of a decoder,

FIG. 3 illustrates an encoder according to an embodiment,

FIG. 4 illustrates a decoder according to an embodiment,

FIG. 5 illustrates an encoder according to a further embodiment,

FIG. 6 illustrates a decoder according to a further embodiment,

FIG. 7 illustrates a determination of a motion-predicted picture according to an embodiment,

FIG. 8 illustrates an encoder using transform coding according to an embodiment,

FIG. 9 illustrates a decoder using transform coding according to an embodiment,

FIG. 10 illustrates a motion-estimation according to an embodiment,

FIG. 11 illustrates a motion-estimation network according to an embodiment,

FIG. 12 illustrates a further example of a motion estimation according to an embodiment,

FIG. 13 illustrates an interpolation in the motion space according to an embodiment,

FIG. 14 illustrates a feature optimization according to an embodiment,

FIG. 15 illustrates experimental RD-results for embodiments,

FIG. 16A-D illustrate experimental results of embodiments for individual sequences.

### DETAILED DESCRIPTION OF THE INVENTION

Embodiments of the present invention are now described in more detail with reference to the accompanying drawings, in which the same or similar elements or elements that have the same or similar have the same reference signs assigned or are identified with the same name. In the following description, a plurality of details is set forth to provide a thorough explanation of embodiments of the disclosure. However, it will be apparent to one skilled in the art that other embodiments may be implemented without these specific details. In addition, features of the different embodiments described herein may be combined with each other, unless specifically noted otherwise.

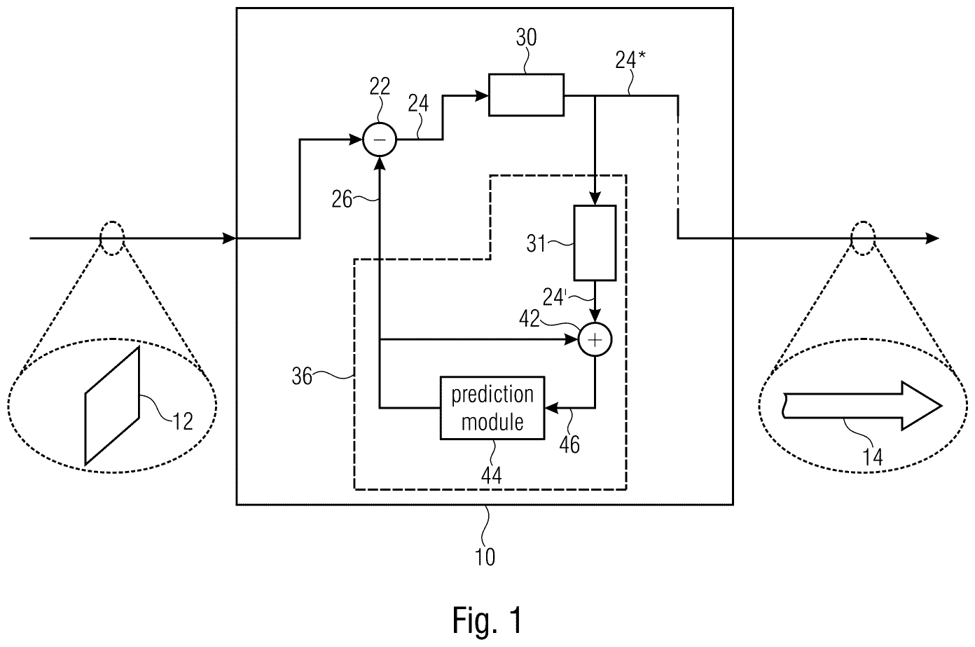

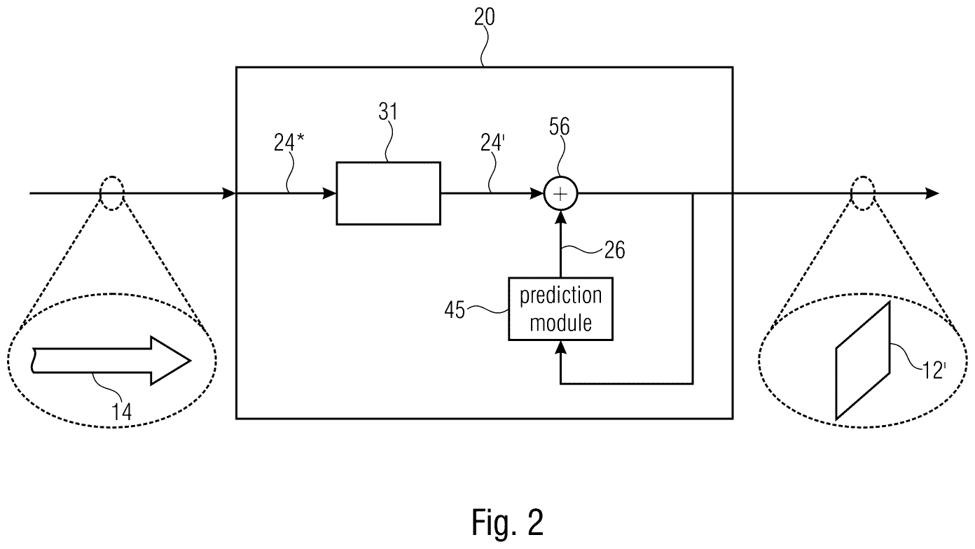

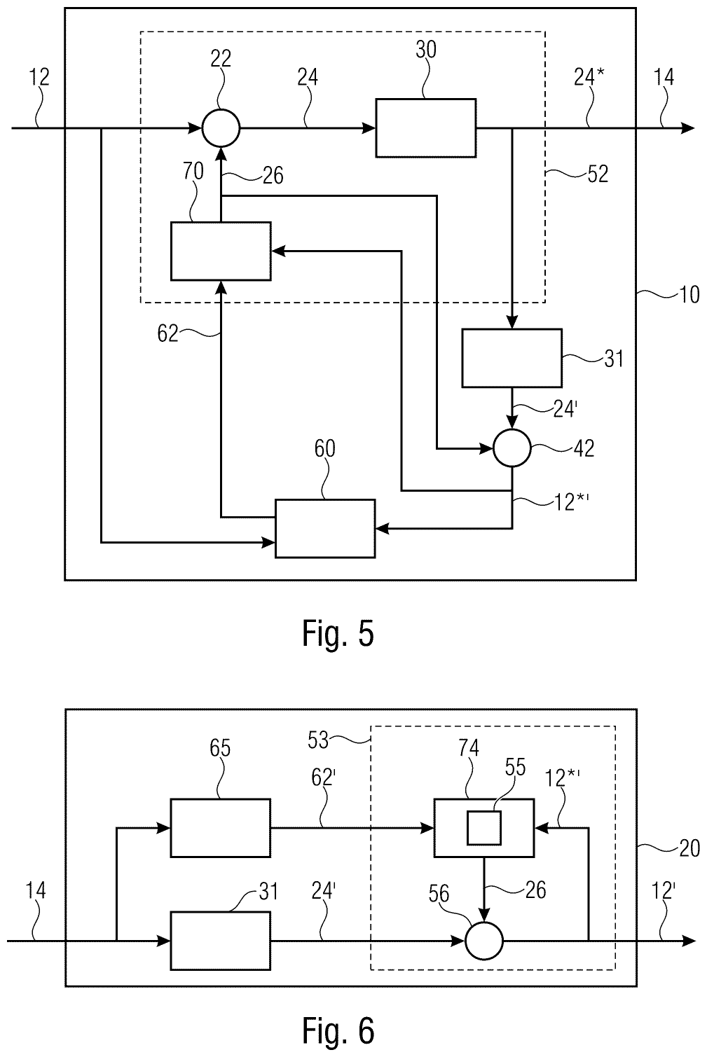

The following description of the figures starts with a presentation of a description of an encoder and a decoder of a predictive codec for coding pictures of a video in order to form an example for a coding framework into which embodiments of the present invention may be built in. The respective encoder and decoder are described with respect to FIGS. 1 to 2. Thereinafter the description of embodiments of the concept of the present invention is presented along with a description as to how such concepts could be built into the encoder and decoder of FIGS. 1 to 2, respectively, although the embodiments described with the subsequent FIG. 5 and following, may also be used to form encoders and decoders not operating according to the coding framework underlying the encoder and decoder of FIGS. 1 to 2.

FIG. 1 illustrates an apparatus 10 for predictively coding a picture 12 into a data stream 14. FIG. 2 shows a corresponding decoder 20, i.e. an apparatus 20 configured to predictively decode the picture 12′ from the data stream 14, wherein the apostrophe has been used to indicate that the picture 12′ as reconstructed by the decoder 20 may deviate from picture 12 originally encoded by apparatus 10 in terms of coding loss, e.g. introduced by a quantization of the prediction residual signal.

Encoder 10 comprises a prediction stage 36, which is configured for predicting the picture 12. That is, prediction stage 36 provides a prediction signal 26 for the picture 12. The encoder 10 may comprise a prediction residual signal former 22, which generates a residual signal 24 so as to measure a deviation of the prediction signal 26 from the original signal, i.e. from the picture 12. The prediction residual signal former 22 may, for instance, be a subtractor which subtracts the prediction signal from the original signal, i.e. from the picture 12, but other operation than a subtraction are feasible as well. In other words, encoder 10 derives a residual signal 24 based on the picture 12 and the prediction signal 26, e.g. by subtracting the prediction signal 26 from the picture 12 to obtain the residual signal 24.

According to embodiments, the prediction signal 26 for forming the residual picture 24 may signal a motion-predicted picture, which may, accordingly, be referred to using the same reference sign. The motion-predicted picture 26 is derived from a previous picture, i.e. a previously coded picture according to a coding order of pictures of a video. Consistently, the residual signal 24 obtained for picture 12 is also referred to as residual picture 24.

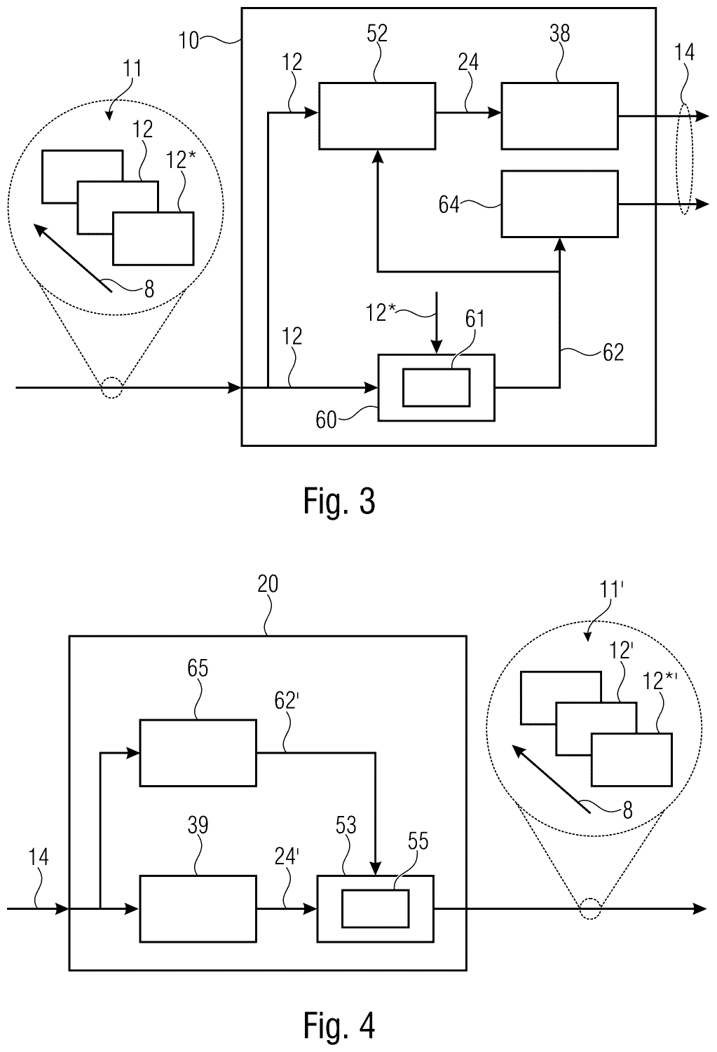

The encoder 10 is configured to encode the residual picture 24, e.g. using encoding stage 30 shown in FIG. 1, to obtain an encoded residual signal, or encoded residual picture 24*. For example, encoding stage 30 may apply transform coding, e.g., block-based transform coding for encoding the residual picture 24, e.g. as described with respect to FIGS. 3 and 4. Alternatively, the encoding stage 30 may use an end-to-end trained machine learning predictor, e.g. and end-to-end trained auto encoder, for encoding the residual picture 24. The encoded residual signal 24* is coded into bitstream 14. To this end, encoder 10 may optionally comprise an entropy coder, e.g. an arithmetic coder, which entropy codes the residual signal into data stream 14. The entropy coder may be part of the encoding stage 30, and thus be part of the prediction loop, e.g., in examples using an end-to-end trained machine learning predictor, the encoding stage 30 may comprise the machine learning predictor in combination with a hyper encoder/decoder for transmitting probabilities for the entropy coding. Alternatively, the entropy coder may be arranged outside of the prediction loop, e.g. in examples using transform coding, e.g. entropy coder 34 shown in the example of FIG. 3. The latter alternative is indicated in FIG. 1 by means of the dashed connection between the encoding stage 30 and the generated data stream 14.

Likewise, the decoder 20 is configured to decode the residual picture from the data stream 14, e.g. using decoding stage 31 shown in FIG. 2, to obtain a reconstructed residual picture 24′. To this end, the decoder operation of decoding stage 31 may be the inverse of the encoder operation performed by encoding stage 30, e.g. in examples using transform coding, e.g. as described with respect to FIG. 3 or 4. In examples using machine learning predictors for encoding the residual signal in the encoding stage 30, the decoding stage 31 may use a further machine learning predictor, e.g. referred to as decoding network, the further machine learning predictor, e.g., being configured for reconstructing the residual picture to obtain the reconstructed residual picture 24′. Thus, the further machine learning predictor of the decoding stage 31 may act a counterpart of the machine learning predictor used by encoding stage 30 for encoding the residual picture, and encoding stage 30 and decoding stage 31 may be trained end-to-end, e.g. with respect to a rate-distortion measure of the reconstructed residual picture 24′ or the reconstructed picture 12′.

Furthermore, decoder 20 may optionally comprise an entropy decoder. Equivalent to the entropy coder of encoder 10, the entropy decoder of decoder 20 may optionally be part of the decoding stage 31, or alternatively, the entropy decoder may entropy decode the residual signal from the data stream 14 to provide the encoded residual signal to decoding stage 31 for reconstruction. In the above-mentioned examples, in which the decoding stage uses the further machine-learning predictor, the entropy decoder may comprise a hyper decoder, i.e. another machine learning predictor, for deriving the probabilities of the entropy decoding from the data stream.

Encoding stage 30 may include a quantization of the residual signal 24, and decoding stage 31 may include a corresponding dequantization, e.g. a scaling, or a mapping from quantization indices to reconstruction levels. Thus, the reconstructed residual picture 24′ may deviate from the residual picture 24 in terms of coding loss, as already described.

The prediction signal 26 is generated by prediction stage 36 of encoder 10 on the basis of the residual signal 24* encoded into, and decodable from, data stream 14. To this end, the prediction stage 36 may subject the encoded residual picture 24* to the decoder operation, e.g. equivalent as performed by decoder stage 31 of decoder 20, to obtain the reconstructed residual signal 24′. A combiner 42 of the prediction stage 36 then recombines, such as by addition, or, in general by an inverse operation of the operation performed by residual former 22, the prediction signal 26 (e.g. of a yet previous picture, i.e. a previous picture of the previous picture) and the prediction residual signal 24′ so as to obtain a reconstructed signal 46, i.e. a reconstruction of the original signal 12′, potentially including coding loss. Reconstructed signal 46 may correspond to signal 12′. A prediction module 44 of prediction stage 36 then generates the prediction signal 26 on the basis of signal 46 by using, for instance, spatial prediction, i.e. intra-picture prediction, and/or temporal prediction, i.e. inter-picture prediction. In particular, according to embodiments, prediction module 44 uses motion prediction, e.g. as described in the following. It is noted that for starting picture, or other intra-coded pictures, the prediction signal may be zero.

Likewise, decoder 20, as shown in FIG. 2, may comprise components corresponding to, and interconnected in a manner corresponding to, prediction stage 36. In particular, decoder 20 may comprise a combiner 56 and prediction module 45, interconnected and cooperating in the manner described above with respect to the modules of prediction stage 36 and the residual former 22, to recover the reconstructed picture 12′ on the basis of residual picture 24* so that, as shown in FIG. 2, the output of combiner 56 results in the reconstructed signal, namely picture 12′. In particular, as mentioned before, reconstructed picture 46 of FIG. 1 may correspond to the reconstructed picture 12′ of FIG. 2, and, accordingly the decoder-sided prediction module 45 may operate equivalently to, or may correspond to, the encoder-sided prediction module 45.

As already outlined above, FIGS. 1 to 2 have been presented as an example where the inventive concept described further below may be implemented in order to form specific examples for encoders and decoders according to the present application. Insofar, the encoder and decoder of FIGS. 1 and 2, respectively, may represent possible implementations of the encoders and decoders described herein below. FIGS. 1 and 2 are, however, only examples.

FIG. 3 illustrates an apparatus 10 for encoding a picture 12 of video 11 into a data stream 14 according to an embodiment. The apparatus 10 is also referred to as encoder 10. Encoder 10 comprises a motion-estimation module 60, which uses a machine learning predictor 61, which may be referred to as first machine learning predictor, to derive a set of features 62. The set of features represents a motion estimation for the picture 12, which may be referred to as the current picture, or currently coded picture, with respect to a previous picture 12* of a coding order 8, according to which the pictures of the video 11 are coded. The motion estimation performed by module 60 is based on the picture 12 and the previous picture 12*, wherein the information about the previous picture 12*, which is used by the motion estimation module 60, may be derived from the residual picture 24, e.g., as will be described below. The features 62 are used by a prediction stage 52 of encoder 10 for predicting the picture 12* to derive a residual picture 24. Encoder 10 further comprises a feature coding module 64 for encoding the features 62 into the data stream 14, and a residual coding module 38 for encoding the residual picture 24 into the data stream 14. It is noted, that the illustration of the feature encoding module 64 in FIG. 3 is illustrative, and that the feature encoding module 64 may optionally be integrated, entirely or partially, into the prediction stage 52.

Accordingly, encoder 10 encodes features 62, representing a motion estimation for picture 12 with respect to previous picture 12*, as well as the residual picture 24 into the data stream. Although features 62 are transmitted in the data stream 14 in addition to the residual 24 of the actual picture 12, the gain of coding efficiency caused by the exploitation of motion estimation may overcompensate the data rate of feature 62 in the data stream 14, so that the disclosed coding scheme may provide an overall gain in coding efficiency, e.g., in terms of rate-distortion.

For example, the first machine learning predictor 61 is a first neural network, e.g. encoding network Enc in the notation of section 2 below, e.g., a downsampling convolutional neural network.

The previous picture 12* is, e.g., a picture preceding the current picture according to a coding order, e.g., coding order 8, among pictures of the video 11, the coding order indexed with index i. For example, but not necessarily, the previous picture is the directly preceding picture in the coding order. In other examples, there may be further pictures in the coding order between the current and the previous picture, i.e., the current picture may be, relative to the previous picture xᵢ, picture xᵢ₊ₖ, with k a positive number>0; Therefore, the index i+1 used throughout the claims and the description is to be understood a non-limiting illustrative example of the general case using index i+k.

The prediction stage 52 may, for example, use the features 62 for obtaining a (motion compensated) reference picture 26 based on a previous picture 12* of the video, and derive a residual picture 24 based on the picture 12 and the reference picture 26.

According to an embodiment, encoder 10 encodes, e.g. in block 38, the residual picture 24 independent of residual pictures of previously coded pictures of the video.

FIG. 4 illustrates an apparatus 20 for decoding a picture 12′ of video 11′ from a data stream 14 according to an embodiment. Apparatus 20 is also referred to as decoder 20. Decoder 20 comprises a feature decoding module 65 for decoding a set of features 62′ from the data stream. The set of features represent a motion estimation for the picture 12′, with respect to a previous picture 12*′. Again, the apostrophe is used to indicate, that the picture or video, or in general a signal, differs from a corresponding signal, e.g. an original signal encoded into the data stream by an encoder, such as encoder 10, by a coding loss. In examples, features 62′ may be quantized feature, e.g. quantized with respect to features 62. Decoder 20 further comprises a residual decoding module 65, which is for decoding a residual picture 24′ from the data stream. Decoder 20 comprises a reconstruction module 53, which uses a machine learning predictor 55 to reconstruct the picture 12′ based on the residual picture 24′ and the features 62′.

In the following, exemplary embodiments for the interplay between the residual coding and the motion-estimation are described.

For example, the machine learning predictor 55 may be a neural network, e.g. an upsampling convolutional neural network. In examples, machine learning predictor 55 corresponds to decoding network Dec of section 2.

According to an embodiment, decoder 10 decodes decodes the residual picture 24′ independent of residual pictures of previously decoded pictures of the video 11.

For example, encoder 10 of FIG. 3 may optionally be implemented like encoder 10 of FIG. 1, and decoder 20 may optionally be implemented like decoder 20 of FIG. 2, as it is exemplarily illustrated in FIG. 5 and FIG. 6.

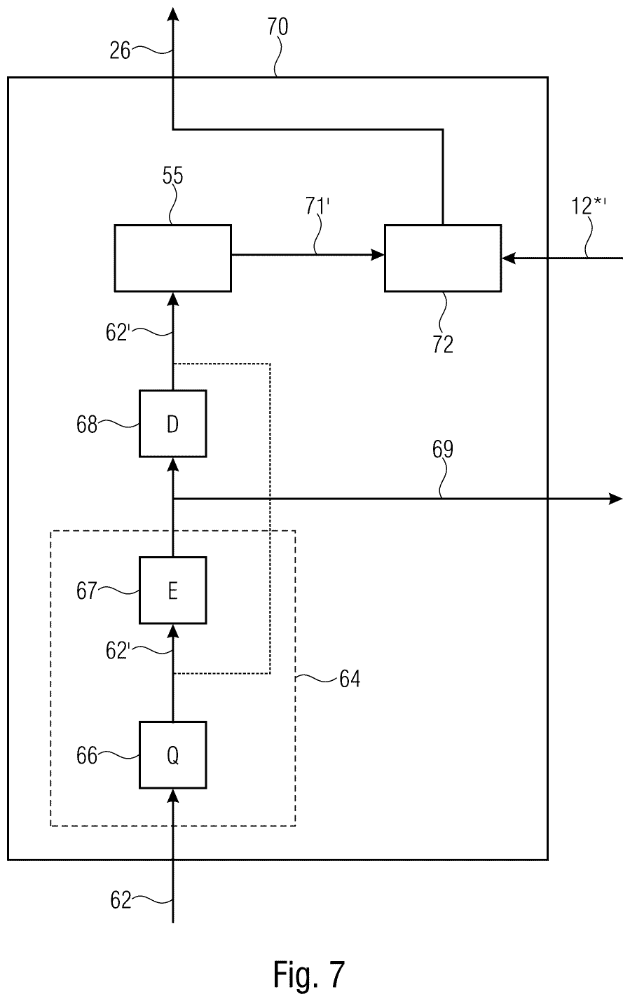

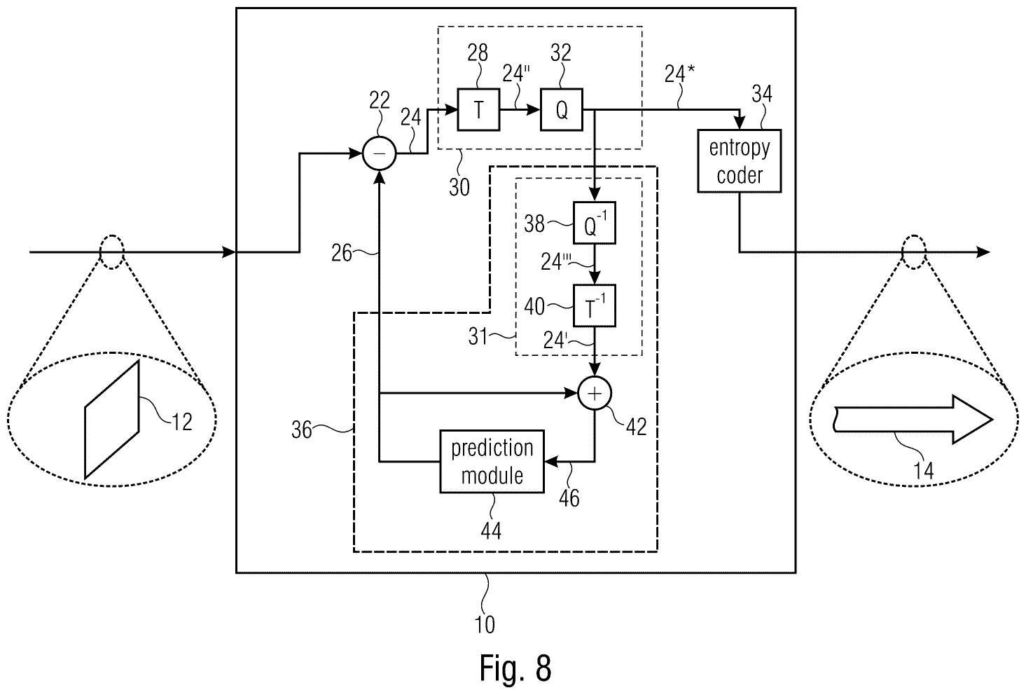

As illustrated in FIG. 5, the motion-predicted picture 26 may be provided by a motion-predicted picture forming module 70 on the basis of the features 62 and a reconstructed previous picture 12*′, the latter being derived from the previous picture 12* as described with respect to FIG. 1. It is noted that signal 46 of FIG. 1 may correspond to the reconstructed previous picture 12*′. In particular, module 38 of FIG. 3 may optionally correspond to encoding module 30 of FIG. 1, and that decoding module 39 of FIG. 4 may optionally correspond to decoding module 31 of FIGS. 1 and 2. As shown in FIG. 5, module 52 of FIG. 3 may include module 70 of FIG. 5 and the residual former 22. It is noted, that feature encoding module 64 may be part of module 70, e.g. as described in FIG. 7. Further, it is noted, that prediction module 44 of FIGS. 1 and 8 may correspond to module 70 of FIG. 5, or a combination of modules 60 and 70 of FIG. 5.

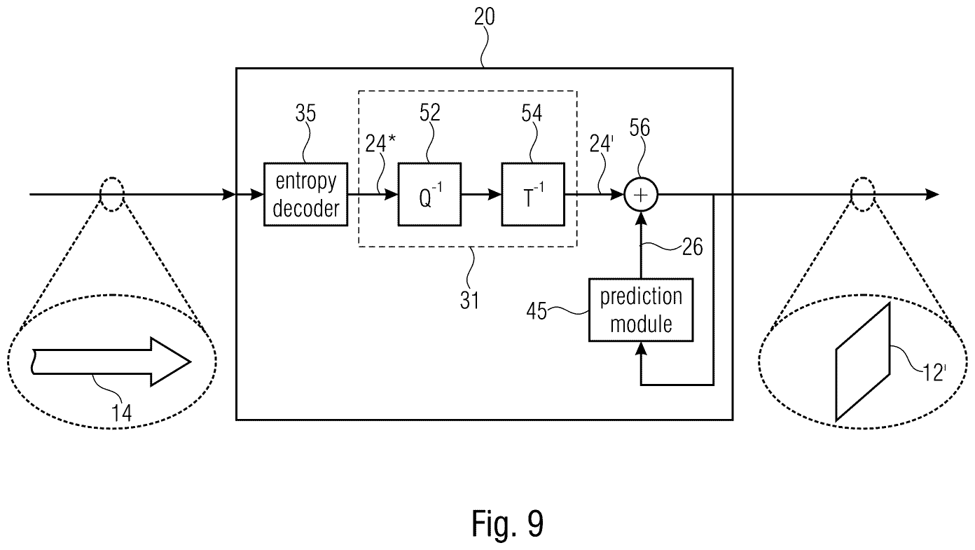

Similarly, on decoder side, the reconstruction module 53 may include the combiner 56, and a motion-predicted picture forming module 74, which provides the motion-predicted picture 26 based on the features 62′, and based on the reconstructed previous picture 12*′. To this end, module 74 may use the machine learning predictor 55 to reconstruct a set of motion vectors, i.e. reconstructed motion vectors. These may be used to obtain the motion-predicted picture 26 based on the reconstructed previous picture 12′*. Prediction module 45 of FIGS. 2 and 9 may correspond to module 74 of FIG. 6.

FIG. 7 illustrates an example of motion-predicted picture forming module 70 of encoder 10. As already mentioned, module 70 may comprise the feature encoding module 64, which may comprise a quantizer 66 and an encoder 67. Encoder 67 may be an arithmetic encoder. The encoded features 69 may be decoded by a decoder 68, which may be an arithmetic decoder, to provide reconstructed features 62′. E.g., decoder 68 corresponds to feature decoder 65 of FIG. 4. The reconstructed features may be input to the machine learning predictor 55, e.g. referred to as decoding network, or decoder, e.g. Dec, to obtain a set of reconstructed motion vectors 71′. The reconstructed motion vectors 71′ may be used by motion-prediction block 72 to obtain the motion-predicted picture 26 based on the reconstructed previous picture 12*′. It is noted that block 68 is optional in encoder 10. As indicated in FIG. 7, as an alternative, quantized features 62′ may be directly input to the machine learning predictor 55.

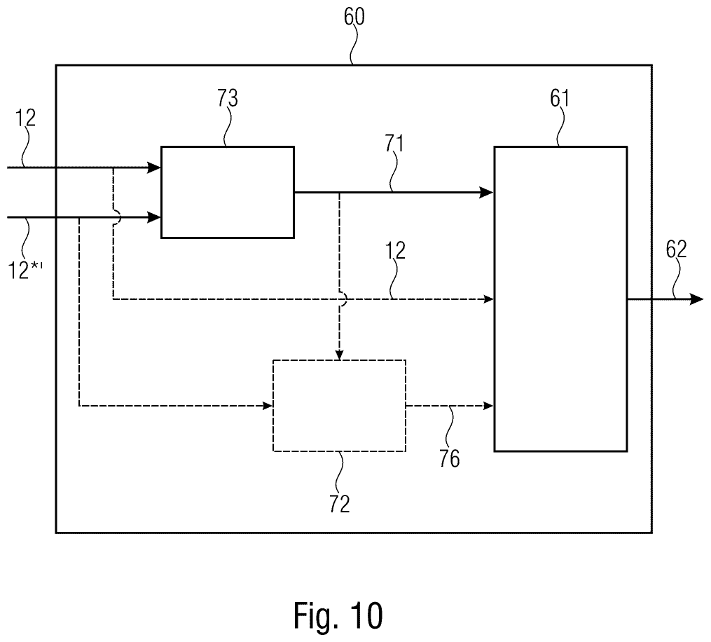

More generally, the motion-predicted picture forming module 70 may determine reconstructed motion vectors 71′, which may, e.g., differ from motion vectors 71 (see FIG. 10), in terms of a deviation introduced by the process of encoding motion vectors 71 by means of the machine learning predictor 61 to obtain the features 62, quantization of features 62, and decoding the dequantized features 62′ by means of machine learning predictor 55. In other words, module 70 may derive, e.g. based on motion vectors 71, the reconstructed motion vector 71′ as they are available to decoder 20. Module 70 may then use the reconstructed motion vectors 71′ together with reconstructed previous picture 12*′ (which may similarly be derived to correspond to the previous picture as available to decoder 20) to determine the motion-predicted picture 26.

Thus, according to an embodiment, encoder 10 is configured for determining a set of reconstructed motion vectors 71′ based on the features 62, deriving 72 a motion-predicted picture 26 (e.g., x̅ᵢ₊₁ in the notation of section 2) (e.g. a predicted picture, which is predicted based on the motion estimation between the picture and the (reconstructed) previous picture; with respect to the indexing of the motion-predicted picture, it is noted that the motion-predicted picture, which is obtained based on the reconstructed picture \hat{x}ᵢ, and which is used for prediction the current picture xᵢ₊₁ (or, in general, xᵢ₊ₖ)) based on a reconstructed previous picture 12* (e.g., \hat{x}ᵢ) (e.g. a reconstruction of the previous picture, e.g. referred to as reference frame) using the set of reconstructed motion vectors 71′, and deriving the residual picture 24 based on the picture 12 (e.g., xᵢ₊₁) and the motion-predicted picture 26 (e.g. the residual picture is a residuum between the picture and the motion-predicted picture; e.g., deriving the residual picture by subtracting the motion-predicted picture from the picture).

For example, module 70 may derive the reconstructed motion vectors 71′ by quantizing the features 62, and using a machine learning predictor, which may correspond to machine learning predictor 55 of decoder 20, to derive the reconstructed motion vectors based on the quantized features.

Thus, as illustrated in FIG. 7 as an optional implementation of motion-predicted picture forming module 70, according to an embodiment, encoder 10 is configured for configured for quantizing 66 the features (62) to obtain quantized features 62′ (e.g., 2), and encoding 67 the quantized features 62′ into the data stream using arithmetic encoding. According to this embodiment, encoder 10 further uses a second machine learning predictor 55 (e.g. decoding network Dec, e.g. a neural network, e.g. an upsampling convolutional neural network) to determine the set of reconstructed motion vectors 71′ (e.g., f) based on the quantized features 62′. Further, encoder 10 may derive, see motion-prediction block 72 of FIG. 7, a motion-predicted picture 26 (e.g., x̅ᵢ₊₁) based on reconstructed previous picture 12*′ (e.g. \hat{x}ᵢ) using the set of reconstructed motion vectors 71′. E.g., reconstructed previous picture 12*′ is a reconstruction of the previous picture. The motion-predicted picture 26 is, e.g., a predicted picture, which is predicted based on the motion estimation between the picture and the (reconstructed) previous picture. With respect to the indexing of the motion-predicted picture, it is noted that the motion-predicted picture, which is obtained based on the reconstructed picture \hat{x}ᵢ, and which is used for prediction the current picture xᵢ₊₁ (or, in general, xᵢ₊ₖ).

Further, encoder 10 may derive (see, e.g. operator 22 of FIG. 4, which is, e.g., a subtractor) the residual picture 24 based on the picture 12 (e.g., a reconstructed version thereof) and the motion-predicted picture 26. E.g. the residual picture is a residuum between the picture and the motion-predicted picture. For example, encoder 10 derives the residual picture by subtracting the motion-predicted picture 26 from the picture 12.

For example, encoder 10 is configured for deriving the reconstructed previous picture 12*′ by decoding an encoded version of the previous picture 12*, thereby introducing coding loss. For example, the apparatus encodes the residual picture of the currently coded picture by block-based transform coding (or using a machine learning predictor, e.g. an encoding neural network) followed by a quantization, e.g. block 30 of FIG. 5. The apparatus 10 may subsequently decode the quantized residual picture (e.g., using inverse transform coding, or a decoding neural network, respectively) to obtain a reconstructed residual picture 24′, e.g., block 31 of FIG. 5.

The apparatus may combine the reconstructed residual picture with a previous motion-predicted picture (e.g., combiner 42 of FIG. 6) to obtain a reconstructed picture 12*′. The reconstructed picture may be used as the reconstructed previous picture for a subsequent picture of the picture. The reconstructed previous picture for deriving the motion-predicted picture for the encoding of the current picture may be derived equivalently, starting from the previous picture of the video. However, the encoding and decoding of the previous picture for obtaining the reconstructed previous picture does not necessarily include residual coding.

On decoder side, the motion-predicted picture forming module 74 of decoder 20 (see FIG. 6) may derive the motion-compensated picture 26 similarly or equivalently as described with respect to motion-predicted picture forming module 70, but without first deriving reconstructed features 62′ from features 62, as motion-predicted picture forming module 74 may directly receive reconstructed features 62′, as indicated in FIG. 6. In other words, motion-predicted picture forming module 74 may comprise the second machine learning predictor 55 to determine the reconstructed motion vectors 71′ based on the reconstructed features 62′, and may further comprise motion-prediction module 72 to determine the motion-predicted picture 26 based on the reconstructed previous picture 12*′ and the reconstructed motion vectors 71′. Accordingly, to the extent of machine learning predictor 55 and motion-prediction module 74, the description of module 70 above may also apply to module 74 of decoder 20.

In other words, according to an embodiment, decoder 20 is configured for deriving the motion-predicted picture 26 based on a reconstructed previous picture 12*′ (e.g. a reconstruction of the previous picture) using the set of reconstructed motion vectors 71′.

Further, decoder 20 may reconstruct the picture 12′ based on the residual picture 24′ and the motion-predicted picture 26, see operator 56 in FIG. 6, which may be a combiner. E.g. the residual picture is a residuum between the picture and the motion-predicted picture. For example, decoder 20 derives the picture by combining or adding the motion-predicted picture 26 and the residual picture 24′.

For example, the decoder 20 is configured for deriving the reconstructed previous picture 12*′ by decoding an encoded version of the previous picture 12*; e.g., decoder 20 may decode a quantized residual picture (e.g., using inverse transform coding, or a decoding neural network, respectively) of the picture from the data stream to obtain a reconstructed residual picture 24′. Decoder 20 may combine (see, e.g., combiner 56 of FIG. 6) the reconstructed residual picture 24′ with a previous motion-predicted picture 26 to obtain a reconstructed picture 12′. The reconstructed picture 12′ may be used as the reconstructed previous picture 12′* for a subsequent picture of the picture. The reconstructed previous picture for deriving the motion-predicted picture for the encoding of the current picture may be derived equivalently, starting from the previous picture of the video. However, decoding of the previous picture for obtaining the reconstructed previous picture does not necessarily include residual coding.

The second machine learning predictor 55, as optionally implemented in the motion-predicted picture forming module 70 of encoder 10 and motion-predicted picture forming module 74 of decoder 20 may, according to an embodiment, (e.g., and the first machine learning predictor) comprise (or consists of) a convolutional neural network comprising a plurality of linear convolutional layers using rectifying linear units as activation functions.

According to an embodiment, the second machine learning predictor 55 has a linear transfer function.

According to embodiments, e.g., as already mentioned with respect to FIG. 1 and FIG. 2, and, e.g., as described with respect to FIG. 8 and FIG. 9, the encoder 10 uses transform coding for encoding the residual picture 24, and reconstructing the reconstructed residual picture 24′. Similarly, the decoder may use transform coding for reconstructing the reconstructed residual picture 24′. In the following, it is described with respect to FIG. 8 and FIG. 9 how the encoder 10 and the decoder 20 of FIG. 1 and FIG. 2 may be implemented when using transform coding. The features described with respect to FIGS. 3 to 7 may be integrated into the encoder and the decoder, according to the description of the relationship between the encoders of FIG. 3 and FIG. 5, and the decoder of FIG. 4 and FIG. 6.

FIG. 8 and FIG. 9 illustrate examples of the encoder 10 and the decoder 20, which apply transform coding for encoding the residual picture 24 into the data stream, and for reconstructing the residual picture 24′ from the data stream, respectively.

FIG. 8 shows an example of the apparatus 10, which uses transform-based coding for coding the residual picture 24 into the data stream 14. The apparatus, or encoder, is indicated using reference sign 10. FIG. 9 shows a corresponding decoder 20, i.e. an example of apparatus 20 configured to reconstruct the residual picture 24′ from the data stream 14 also using transform-based decoding, wherein, again, the apostrophe has been used to indicate that the picture 12′ as reconstructed by the decoder 20 deviates from picture 12 originally encoded by apparatus 10 in terms of coding loss, e.g., introduced by a quantization of the prediction residual signal.

According to the example of FIG. 8, the encoding stage 30 of encoder 10 comprises a transformer 28 which subjects the residual picture 24 to a spatial-to-spectral transformation to obtain a spectral-domain prediction residual signal 24″ which is then subject to quantization by a quantizer 32, also comprised by the encoder 10, to obtain the encoded residual picture 24*. The thus quantized prediction residual signal 24* is coded into bitstream 14. To this end, encoder 10 may optionally comprise an entropy coder 34 which entropy codes the prediction residual signal as transformed and quantized into data stream 14. The prediction signal 26 is generated by the prediction stage 36 of encoder 10 based on the encoded residual picture 24*.

Similarly, the decoding stage 31 of decoder 20, but also the one of the prediction stage 36 of encoder 10, comprise a dequantizer 38 which dequantizes the transformed and quantized residual picture 24* so as to gain spectral-domain prediction residual signal 24″, which corresponds to signal 24″ except for quantization loss, followed by an inverse transformer 40 which subjects the latter prediction residual signal 24″ to an inverse transformation, i.e. a spectral-to-spatial transformation, to obtain the reconstructed residual picture 24′, which corresponds to the original residual picture 24 except for quantization loss.

The encoding stage 30 and the decoding stage 31 may employ block-based transform coding. To this end, encoding stage 30 may subdivide the residual picture 24 into blocks, and may perform the spatial-to-spectral transform block-wise, to obtain, for each of the blocks, a resulting transform block in the spectral domain. Similarly, inverse transformer 54 performs the spectral-to-spatial transform on the transform blocks encoded into the encoded residual picture 24* to reconstruct the blocks of the reconstructed residual picture 24′.

In other words, transformer 28 and inverse transformer 54 may perform their transformations in units of these transform blocks. For instance, many codecs use some sort of DST or DCT for all transform blocks. Some codecs allow for skipping the transformation so that, for some of the transform blocks, the prediction residual signal is coded in the spatial domain directly. Furthermore, in accordance with embodiments, encoder 10 and decoder 20 may configured in such a manner that they support one or several transforms. For example, the transforms supported by encoder 10 and decoder 20 could comprise one or more of:
DCT-II (or DCT-III), where DCT stands for Discrete Cosine Transform
DST-IV, where DST stands for Discrete Sine Transform
DCT-IV
DST-VII
Identity Transformation (IT)

Naturally, while transformer 28 would support all of the forward transform versions of these transforms, the decoder 20 or inverse transformer 54 would support the corresponding backward or inverse versions thereof:
Inverse DCT-II (or inverse DCT-III)
Inverse DST-IV
Inverse DCT-IV
Inverse DST-VII
Identity Transformation (IT)

The subdivision of the picture into blocks may be any subdivision, such as a regular subdivision of the picture area into rows and columns of square blocks or non-square blocks, e.g., square blocks of 16×16 samples, or a multi-tree subdivision of picture 12 from a tree root block into a plurality of leaf blocks of varying size, such as a quadtree subdivision or the like.

In more general words, according to an embodiment, encoder 10 is configured for encoding the residual picture 24 using block-based transform coding (e.g. encoding the residual picture 24 in units of blocks by subjecting blocks of the residual picture 24 to a spatial-to-spectral transformation 28 to obtain transform blocks, and encoding the transform blocks into the data stream).

Similarly, according to an embodiment, decoder 20 is configured for configured for decoding the residual picture 24′ using (e.g., inverse) block-based transform coding (e.g. decoding transform blocks of a transformed representation of the residual pictures from the data stream; and decoding the residual picture in units of blocks by subjecting transform blocks to a spectral-to-spatial transformation 54 to obtain blocks of the residual picture).

Further, it is noted, that in examples in which the encoder 10 and decoder 20 employ block-based transform coding, the encoder 10 and decoder 20 may additionally employ intra-prediction of blocks of the picture. To this end, encoder 10 may predict a block of the residual picture 24 based on a previously coded reference block of the same residual picture. Equivalently, decoder 20 may predict a block of the reconstructed residual picture 24′ based on a previously reconstructed reference block of the same residual picture. To this end, the blocks of the residual picture 24′ may be encoded/reconstructed according to a coding order, e.g. a raster scan order defined within the residual picture 24′. Intra-prediction may follow a similar scheme as described with respect to the inter-picture prediction performed by prediction stage 36 and the prediction modules 44, 45, except that the coding steps are performed on different blocks of a residual picture 24′ according to the coding order of the blocks instead of different pictures of a coding order of the pictures of a video, and that the prediction modules 44, 45 perform intra-prediction, e.g. spatial prediction, instead of motion prediction (or motion estimation).

For example, the intra-prediction may form an additional loop, similar to the prediction loop formed by the prediction stage 36. For example, the residual picture 24 may be input to a further residual former, forming a residual between the residual picture 24 and a further prediction signal, which may represent a spatial prediction of a currently coded block, to obtain a residual block. The residual block may be subjected to transformer 28, and quantizer 32, and encoded into the data stream. Further, the quantized transformed residual block is subjected to dequantizer 38, and inverse transformer 40. The reconstructed residual block may be combined, e.g., by means of a further combiner, with the further prediction signal of a preceding block to obtain a reconstructed residual block. The such reconstructed residual block may be input to an intra-prediction module to obtain the further prediction signal for a later block. The entirety of all reconstructed residual blocks may further form the reconstructed residual picture 24′ to be input to combiner 42. Equivalently, on the decoder side, the quantized transformed residual blocks, entropy decoded from the data stream by decoder 35, are subjected to dequantizer 38, and inverse transformer 40. A currently reconstructed residual block may then be combined, e.g., by means of a further combiner, with a further prediction signal of a preceding block to obtain a reconstructed residual block. The such reconstructed residual block may be input to an intra-prediction module to obtain the further prediction signal for a later block. The entirety of all reconstructed residual blocks may further form the reconstructed residual picture 24′ to be input to combiner 56.

In more general words, according to an embodiment, encoder 10 is configured for intra-predicting a block (e.g., a currently coded block) of the residual picture 24 based on a previous block of the residual picture 24 (e.g., so as to exploit spatial correlation within the residual picture 24. E.g., encoder 10 may encode the residual picture in units of blocks according to a coding order among the blocks, e.g. a raster scan order. E.g., the previous block may be a neighboring block in the raster or array, according to which the blocks are arranged within the picture).

Similarly, according to an embodiment, decoder 20 is configured for intra-predicting a block (e.g., a currently coded block) of the residual picture 24′ based on a previous block of the residual picture 24′ (e.g., so as to exploit spatial correlation within the residual picture. E.g., decoder 20 may reconstruct the residual picture in units of block according to a coding order among the blocks, e.g. a raster scan order; E.g., the previous block may be a neighboring block in the raster or array, according to which the blocks are arranged within the picture).

In the following, some optional features of embodiments of the encoder 10 of FIG. 3 and the decoder 20 of FIG. 4 are described in more detail. The described features may optionally also be implemented in the encoders and decoder described with respect to FIGS. 1, 2, and 5 to 9, in the way as described above.

FIG. 10 illustrates an embodiment of the motion-estimation module 60. According to this embodiment, the motion-estimation module 60 comprises a motion estimation network 73 for deriving a set of motion vectors 71 based on the picture 12 and the previous picture 12*, or a reconstructed version thereof. For example the reconstructed previous picture 12*′ may be obtained as described with respect to FIG. 5. The motion vectors 71 derived by the motion-estimation network 73 may represent a deviation, or a motion of content of the current picture 12 with respect to the previous picture 12*. The motion vectors 71 are used as input of the first machine learning predictor 61, which may compress the motion vectors 71 into features 62 for encoding them into the data stream. To this end, the first machine learning predictor 61 may optionally use the picture 12 and/or either the reconstructed previous picture 12*′ or a reference picture 76, which is obtained based on the reconstructed previous picture 12*′ and the motion vectors 71, as inputs. The reference picture 76 may represent an estimation of the motion-predicted picture 26, and may differ from same merely in that it is based on the original motion vectors 71 instead of a reconstructed version thereof.

In more general words, according to an embodiment, encoder 10 derives a set of motion vectors 71 based on the picture 12 and based on the previous picture 12* (e.g., based on a reconstructed version 12*′ thereof, which is obtained from the previous picture 12*) using a motion estimation network 73 (e.g., network_{flow} of the notation below), the motion estimation network comprising a machine learning predictor (e.g. a neural network), e.g., a further machine learning predictor to the first machine learning predictor 61 and optionally to the second machine learning predictor 55. According to this embodiment, the first machine learning predictor 61 is configured for deriving the features 62 based on the set of motion vectors 71.

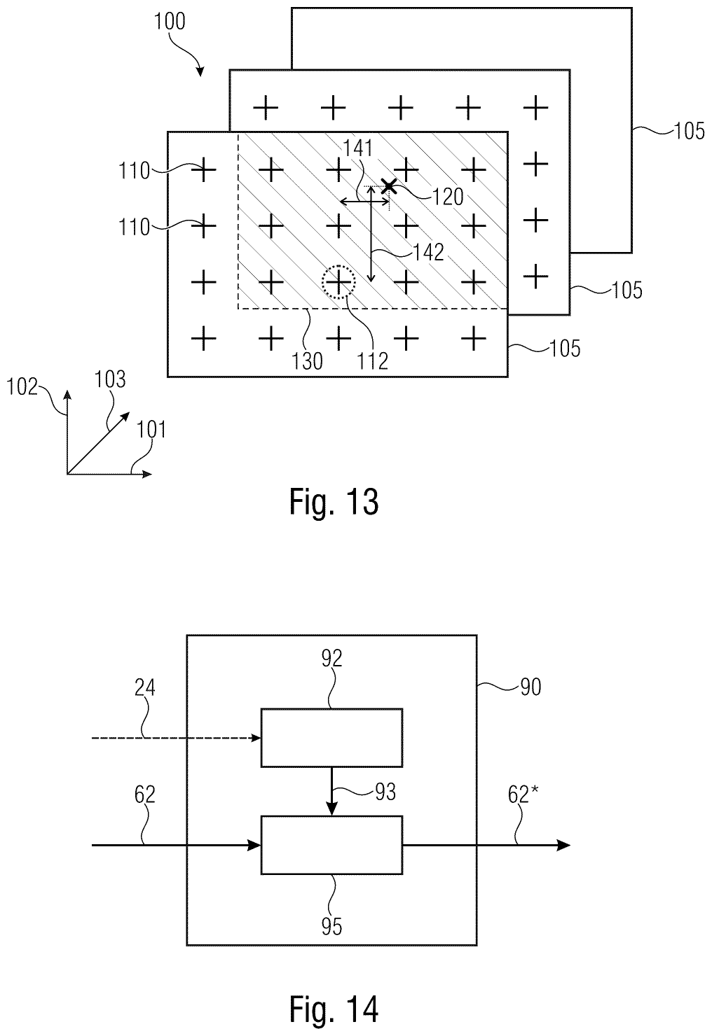

According to an embodiment, the motion vectors 71 represent vectors in a motion space, e.g., motion space 100 described with respect to FIG. 13 below, the motion space being defined by a plurality of pictures comprising a reconstructed previous picture 46 (or 12*′) (e.g., \hat{x}ᵢ), e.g., a reconstruction of the previous picture, and a set of filtered versions of the reconstructed previous picture.

Optionally, as indicated in FIG. 10, according to an embodiment, encoder 10 derives a reference picture 76, e.g. xᵢ₊₁*, (or a further motion-compensated picture, e.g. obtained based on the reconstructed previous picture like the motion compensated picture 26, but using the set of motion vectors 71 instead of the set of reconstructed motion-vectors 71′) based on a reconstructed previous picture 12*′, 46, e.g., \hat{x}ᵢ, (e.g., a reconstruction of the previous picture) using the set of motion vectors 71. According to this embodiment, the first machine learning predictor 61 is configured for receiving, as an input, one or more or all of the picture 12, the reference picture 76, and the set of motion vectors 71.

According to an embodiment, the machine learning predictor of the motion estimation network 73 comprises a convolutional encoder neural network (Enc_{flow}) and a convolutional decoder neural network (Dec_{flow}).

According to an embodiment, the convolutional encoder neural network (Enc_{flow}) comprises a set of downsampling convolutional layers, and the convolutional decoder neural network (Dec_{flow}) comprises a set of upsampling convolutional layers.

According to an embodiment, the machine learning predictor of the motion estimation network 73 comprises a skip connection connecting a convolutional layer of the convolutional encoder neural network with a convolutional layers of the convolutional decoder neural network (e.g., which convolutional layer is associated with the respective convolutional layer of the convolutional encoder neural network).

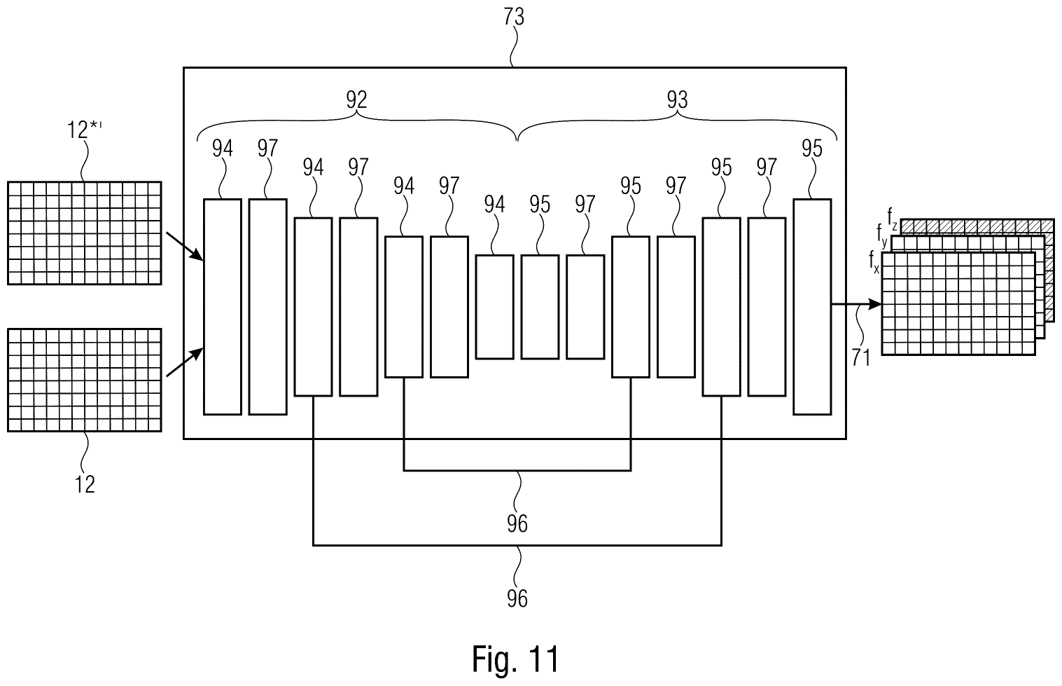

FIG. 11 illustrates an exemplary embodiment of the motion estimation network 73. According to this embodiment, the machine learning predictor of the motion estimation network is a convolutional neural network, comprising a convolutional encoding network 92, and a convolutional decoding network 93, each comprising a plurality of convolutional layers. While the convolutional layers 94 of the encoding network 92 are downsampling layers, the convolutional layers 95 of the decoding network are upsampling layers. The convolutional layers may use activation functions 97, e.g. rectifying linear units, ReLUs. E.g. each of the convolutional layers, except for the respective last layers of the encoding and decoding networks may be followed by such an activation. Optionally, skip connections 96 may be used pairwise between layers of the encoding and decoding network. An exemplary implementation of the layers in terms of number of layers, channel numbers, kernel size, stride, etc. is described with respect to FIG. 11 in section 2 below. However, other implementations are possible.

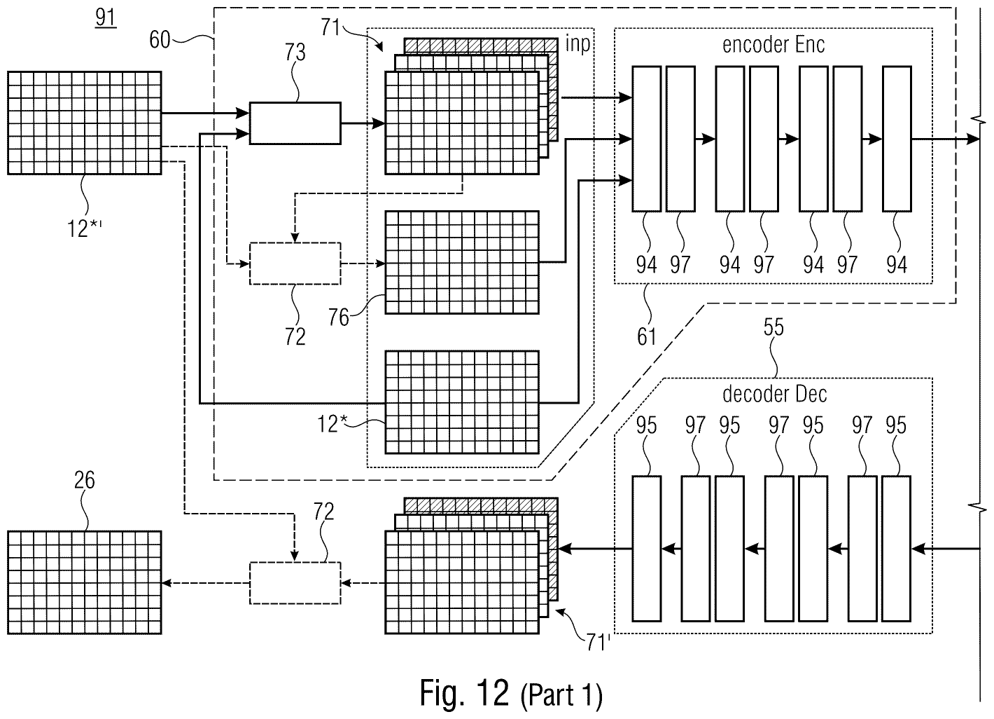

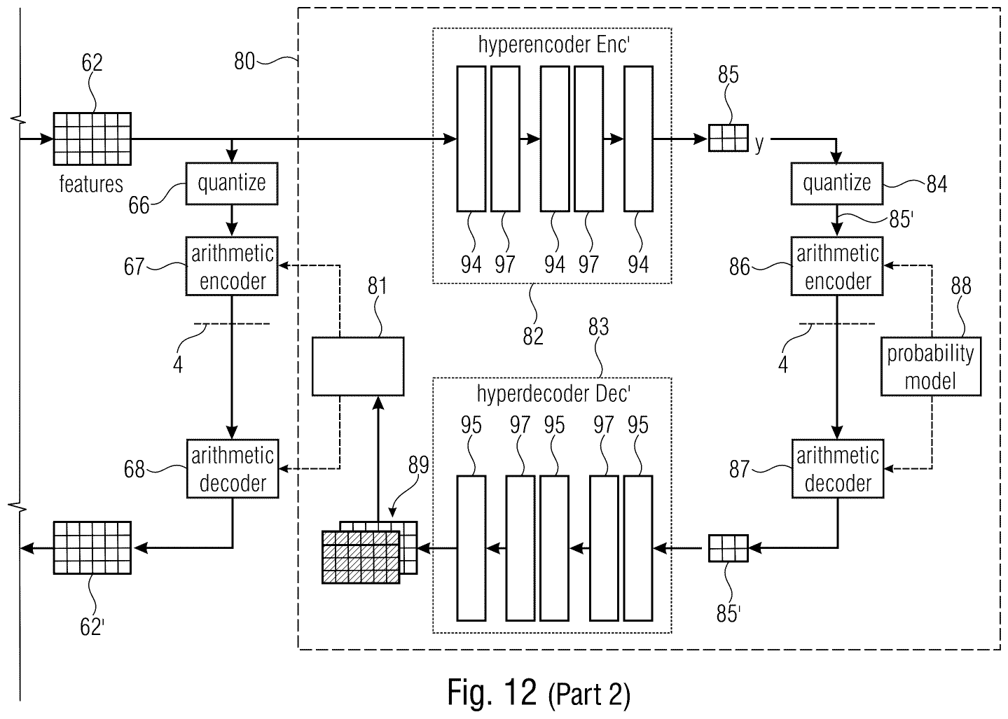

According to examples of the encoder 10 and the decoder 20 described with respect to FIGS. 1 to 10, the features 62 are encoded into the data stream 14 using entropy coding, e.g. by means of encoder 67 of FIG. 7. According to examples, the probability model for the entropy coding of the features is signaled in the data stream 14. An example thereof is described with respect to a FIG. 12 in the following, in particular with respect to block 80 shown therein. It is noted, that the signaling of the probability model performed by block 80 may be implemented in the encoders and decodes previously described independent of the further details shown in FIG. 12. For signaling the probability model, encoder 10 may use a further machine learning predictor 82, referred to as hyper encoder, e.g. a convolutional neural network, e.g. a downsampling convolutional neural network, for deriving a set of hyper parameters 85, quantize them using quantizer 84, and encode them into the data stream, optionally using arithmetic encoding. Decoder 20 may decode the quantized hyper parameters 84′ from the data stream, optionally using arithmetic decoding. Both encoder 10 and decoder 20 may derive probability parameters for the probability model based on the quantized hyper parameters 84′ using a yet further machine learning predictor 83, referred to as hyper decoder, e.g., a e.g. a convolutional neural network, e.g. an upsampling convolutional neural network. It should be noted, that specific details shown in FIG. 12, such as the implementation of the hyper decoder, the hyper encoder, i.e. the exact number of layers, channel numbers, kernel sizes, and the way of quantization are merely examples, and may also be implemented differently.

FIG. 12 illustrates an exemplary implementation of a motion-estimation 91, as it may optionally be performed by encoder 10 and decoder 20 of FIGS. 1 to 10. FIG. 12 may be a For example, the motion-estimation 91 may optionally replace modules 60 and 70 of FIG. 5, e.g. in accordance with any of the embodiments described with respect to FIGS. 3 to 10. It should be noted, that specific details described with respect to FIG. 12, such as the implementation of the encoder, the decoder, the hyper encoder, and the hyper decoder, e.g. the exact number of layers, channel numbers, kernel sizes, and the way of quantization are merely examples, and may also be implemented differently.

FIG. 12 illustrates, among further aspects, an example of a hyper system 80, as it may be part of the encoder 10, and partially of decoder 20, according to an embodiment. According to this embodiment, encoder 10 encodes, e.g. in block 67 of FIG. 7, the features 62, e.g. the quantized feature 62′, into the data stream 14 using entropy coding, e.g., arithmetic coding. Encoder 10 may determine a probability model 81, e.g. a conditional probability model, e.g. P_{z} described below, for the entropy encoding. For example, the quantized features 62′ are derived by quantizer 66 from features 62, e.g., using the operation

$$\hat{z} = ⌊ \frac{z}{Δ} + \frac{1}{2} ⌋ .$$

E.g., Δ denotes a quantization parameter, e.g. a quantization step size.

According to an embodiment, encoder 10 determines the probability model 81 by means of a hyper system 80, e.g. as illustrated in FIG. 12. Hyper system 80 comprises a hyper encoder 82, also referred to as Enc′, which derives hyper parameters 85, also referred to as hyper priors y, e.g., y=Enc′(z), based on the features 62. Hyper system 80 further comprises a quantizer 84, e.g. a further quantizer to quantizer 66, to quantize the hyper parameters 85, e.g. using operation

$$\hat{y} = ⌊ y + \frac{1}{2} ⌋$$

to obtain quantized hyper parameters 85′, e.g., ŷ below. The quantized hyper parameters 85′ are encoded using entropy coding, e.g. arithmetic coding, see block 86, and may be provided in data stream 14, e.g. as hyper prior bits. The arithmetic encoding 86 may use a probability model 88, e.g. probability model P_{y} described below, which may be static probability model. E.g., parameters for the probability model 88 may be fixed. Alternatively, parameters for the probability model may be transmitted in the data stream 14.

Additionally, encoder 10 may comprise, as part of the hyper system 80, a hyper decoder 83, e.g. referred to as Dec′, which determines a parametrization 89 for the probability model 81 based on reconstructed hyper parameters 85′. In examples, the hyper decoder 83 may receive the quantized hyper parameters as provided by further quantizer 84 as input. Alternatively, the hyper system 80 of encoder 10 may comprise an entropy decoder 87, which entropy decodes, e.g. arithmetically decodes, the encoded hyper parameters provided by entropy encoder 86 to provide reconstructed hyper parameters 85′, which may be provided to the hyper decoder 83 as input.

For example, the parametrization 89 may comprise a mean and a variance of a probability density function, see, e.g., (\hat{μ}, \hat{σ})=Dec′(ŷ).

For example, the parametrization 89 may comprise for each feature 62, or for each of samples of features 62, a respective parametrization for the probability model 88 for the arithmetic encoding 67 and decoding 68 of the respective feature/sample.

The hyper encoder 82 may be implemented as, or may comprise, a machine learning predictor, which may be referred to as third machine learning predictor. The hyper decoder 83 may be implemented as, or may comprise, a further machine learning predictor, which may be referred to as fourth machine learning predictor.

In more general words, what was described with respect to the hyper system 80, according to an embodiment, encoder 10 is configured for encoding 67 the features 62 (e.g. the quantized features 62′) into the data stream using entropy coding. According to this embodiment, encoder 10 determines a probability model 81 for the entropy coding by subjecting the features 62 to a machine learning predictor 82, referred to as third machine learning predictor, e.g., a neural network, e.g. a downsampling convolutional neural network, e.g. referred to as hyper encoder, to obtain hyper parameters 85, quantizing 84 the hyper parameters, and subjecting the quantized hyper parameters 85′ to a further machine learning predictor 83, referred to as fourth machine learning predictor (e.g., a neural network, e.g. an upsampling convolutional neural network, e.g., referred to as hyper decoder).

As far as the decoder side is concerned, decoder 20 may comprise a portion of hyper system 80, namely entropy decoder 87, e.g. an arithmetic decoder, using the probability model 88 to reconstruct the quantized hyper parameters 85′ from the data stream 14, and hyper decoder 83, deriving, from the reconstructed hyper parameters 85′, the parametrization 89 for the entropy decoding 68 of the features 62, as described with respect to encoder 10.

Accordingly, hyper system 80 may provide the parametrization 89 to be available to both encoder 10 for the entropy encoding 67 of features 62 and an entropy decoder 68, e.g. an arithmetic decoder, which may be part of decoder 20, for entropy decoding the quantized features 62′ from the data stream 14. It is noted that lines 4 are used in FIG. 12 to indicated the transmission between encoder and decoder via data stream 14, but it is noted that components following the lines 4 in the flow may still be part of the encoder, i.e. may be part of both encoder and decoder, to allow the encoder 10 to perform prediction on the same information as available to decoder 20. However, encoder 10 may skip the entropy decoding 68, 87, and may instead directly use quantized feature 62′ as input to decoder 55 and quantized hyper parameters 85′ as input for hyper decoder 83.

FIG. 12 further illustrates exemplary implementations of the first machine learning predictor 61, the second machine learning predictor 55, the hyper encoder 82, and the hyper decoder 83, where reference sign 94 denotes downsampling convolutional layers, reference sign 95 denotes upsampling convolutional layers, and reference sign 97 denotes activation functions. The implementation of FIG. 12 is merely exemplary, and other implementations may be used. An example for a more specific implementation is given below.

Further optional details of FIG. 12 will be described later.

FIG. 13 illustrates an example of an interpolation in the motion space, as it may optionally be performed by encoders 10 and decoders 20 of FIGS. 1 to 12 for determining the motion-predicted picture 26 based on the reconstructed previous picture 12*′ and the (reconstructed) motion vectors 71, 71′, e.g. by module 72. FIG. 13 illustrates an example of the motion space 100, which may comprise a plurality of two-dimensional sample arrays 105, e.g. the reconstructed previous picture 12*′, and a plurality of filtered versions thereof. Each sample array comprises a plurality of samples 110, located at respective sample positions of the array, and having one or more sample values. For example, all of the sample arrays may have the same dimensions, i.e. same number of samples, but this is not necessarily the case. As illustrated in FIG. 13, a first dimension 101 and a second dimension 102 of the motion pace 100 may be spanned by the two dimensions of the 2D sample arrays, and the a third dimension 103 may be defined by an order among the sample arrays. For example module 72 may derive the motion space based on the reconstructed previous picture 12*′, e.g. by filtering, e.g. using Gaussian filters as described in section 2 below.

The set of motion vectors 71, 71′ may comprise, for each sample of the motion-estimated picture 26, a corresponding motion vector, which indicates a position within the motion space 100. In FIG. 13, such a position indicated by a motion vector is indicated using reference sign 120, and referred to as motion vector position in the following. The coordinates of the motion vector may have subsample precision, i.e. indicate positions between samples of the motion space.

Module 72 may derive a sample value for a sample of the motion-estimated picture 26 based on samples of the motion space 100, which samples are located within a region 130 around the motion vector position 120. E.g., the region may be symmetric around the motion vector position. At the borders, however, the region may be cropped, as in FIG. 13.

According to embodiments, module 72 weights the samples within the region to determine the sample value for the motion-predicted picture 26, e.g. form a weighted sum of the sample values of the samples within region 140.

According to embodiments, module 72 uses one or more Lanczsos filters, e.g. as in equation (5) of section 3 below. E.g., for each of the two dimensions of the 2D sample array 105, one Lanczos filter is applied. This means, for example, that module determines the weight for a sample, e.g. sample 112 in FIG. 13, by determining, a first distance 141 between the sample 112 and the motion vector position 120 with respect to the first dimension 101, and a second distance 142 between the sample 112 and the motion vector position 120 with respect to the second dimension 102. Both the first and second distances may be used as argument for a Lanczos filter, to obtain a first weight and a second weight, respectively. The module may determine the weight for sample 112 by multiplying the first and second weights.

Further, a third weight may be determined with respect to the third dimension. That is, the region 130 may be three-dimensional, and may include the samples of multiple arrays, e.g., two neighboring arrays. For the third dimension, another filter may be used, e.g. a linear filter with respect to the distance between the sample 112 and the motion vector position 120 in the third dimension.

According to embodiments, the distances 141, 141 may be measured in fractional sample position precision. That is, for example, the distances used as argument for the Lanczos filters may be limited to a precision of a certain fraction of the distance between two samples (the distance between two samples may just be 1, as the sample positions may be defined merely by indexing with integer numbers). E.g., the distances may be measured in fractional sample position precision of ½, ¼, ⅛, 1/16, or 1/32, in particular 1/16.

Accordingly, now described in other words, referring back to the description of encoder 10 and decoder 20 with respect to FIGS. 3 to 12, with respect to FIG. 13, optional embodiments of the reconstructed motion vectors 71′, and the derivation of the motion-predicted picture 26 from (reconstructed) motion vectors 71 (71′) and the (reconstructed) previous picture 12* (12*′) are described, as they may, in examples, be implemented in modules 70 and 74 (and block 60 as described with respect to FIG. 10 below) of encoder 10 and decoder 20.

According to an embodiment, the reconstructed motion vectors 71′ represent vectors (e.g., vectors pointing to positions) in a motion space (or scale space volume X, e.g., the motion vectors comprise a coordinate for each dimension of the motion space, so as to indicate a position within the motion space), the motion space being defined by a plurality of pictures comprising the previous picture and a set of filtered versions of the previous picture (e.g. blurred versions, filtered by convolution with respective Gaussian kernels) (and, e.g., wherein the motion space is spanned in a first dimension and a second dimension by first and second dimensions of 2D sample arrays of the pictures, and in a third dimension by an order among the plurality of pictures). For example, the motion space may be as described with respect to FIG. 13.

According to an embodiment, the set of reconstructed motion vectors 71′ comprises, for each of a plurality of samples of the motion-predicted picture 26, a corresponding reconstructed motion vector. Further, according to this embodiment, encoder 10/decoder 20 is configured for deriving a sample of the motion-predicted picture 26 by weighting a set of samples of the motion space, the samples of the set of samples being positioned within a region of the motion space, which region is indicated by the corresponding reconstructed motion vector of the of the motion-predicted picture.

According to an embodiment, the set of reconstructed motion vectors 71′ comprises, for each of a plurality of samples of the motion-predicted picture 26, a corresponding reconstructed motion vector (e.g., each sample has a sample position within the picture, i.e. a sample position within a sample array of the picture, and one or more sample values). According to this embodiment, the encoder 10/decoder 20 derives a sample (e.g., a sample value for a sample at a sample position) of the plurality of samples of the motion-predicted picture 26 by weighting a set of samples of the motion space, the samples of the set of samples being positioned within a region of the motion space (e.g., a 3D region), which region is indicated by the corresponding reconstructed motion vector of the sample of the motion-predicted picture. Furthermore, the encoder 10/decoder 20 may weight the samples of the set of samples using one or more Lanczos filters to derive the sample.

According to an embodiment, the motion space is spanned in a first dimension and a second dimension by first and second dimensions of 2D sample arrays of the pictures, and in a third dimension by an order among the plurality of pictures. According to this embodiment, the encoder 10/decoder 20 obtains a weight for one of the samples of the set of samples using a first Lanczos filter for the first dimension of the motion space, and a second Lanczos filter for the second dimension of the motion space (and, e.g., by using a linear filter in the third dimension of the motion space).

For example, the encoder 10/decoder 20 shifts to or centers the Lanczos filter at the position (or value) indicated by the respective coordinate of the motion vector (the coordinate which refers to the respective dimension) (wherein the motion vector coordinate may be rounded to a fractional sample position precision, e.g. 1/16 as) and evaluates the filter using the sample position of the one sample as argument for the filter function to obtain the weight for the one sample.

According to an embodiment, each of the one or more Lanczos filters (e.g., the first and second Lanczos filters) is represented by a windowed sinc filter, e.g., as in equation (5) below.

According to an embodiment, the encoder 10/decoder 20 evaluates the Lanczos filters with a precision of ¼, or ⅛, or 1/16, or 1/32, e.g., in particular 1/16, of a sample position precision of the motion space, e.g., in respective dimensions, to which the Lanczos filters refer. In examples, sample positions are indexed using integer numbers (i.e. the sample position precision is 1), and the Lanczos filters are evaluated with a precision of ¼, or ⅛, or 1/16, or 1/32. In other words, the encoder/decoder 20 may round the arguments for the Lanczos filter (i.e. the distances of a sample position (e.g. integer sample position of the sample of the set of samples in the region) to the position indicated by the respective coordinate of the corresponding motion vector) to fractional sample position precision, e.g. of ¼ or ⅛, or 1/16, or 1/32.

According to an embodiment, the encoder 10/decoder 20 evaluates the Lanczos filters using (e.g. as argument) a distance (or difference) between a sample position of the sample and a position indicated by the corresponding reconstructed motion vector (e.g. a first distance with respect to a first dimension of the motion space for a first Lanczos filter, and a second distance with respect to a second dimension of the motion space for a second Lanczos filter). The encoder 10/decoder 20 may determine the distance with a precision of ¼, or ⅛, or 1/16, or 1/32 of a sample position precision of the motion space (in the respective dimension).

For example, the encoder 10/decoder 20 determines the weight for the sample by combining (e.g. multiplying) respective weights determined for distances regarding multiple (e.g. two or three) dimensions of the motion space.

FIG. 14 illustrates a feature optimization module 90, which may be part of encoder 10 according to an embodiment. Feature optimization module 90 may optionally be combined with any of the details and features described with respect to FIGS. 1 to 13. According to this embodiment, the encoder 10 uses a second machine learning predictor, e.g. second machine learning predictor 55, e.g. decoding network Dec, to determine a set of reconstructed motion vectors 71′ based on the features 62, and encoder 10 derives a motion-predicted picture 26 based on the previous picture 12*, e.g. based on the reconstructed previous picture 12*′, using the set of reconstructed motion vectors 71′, e.g. as described with respect to FIG. 7 (wherein further details of FIG. 7, such as the derivation of the reconstructed features 62′ are optional). According to this embodiment, encoder 10 derives the residual picture 24 based on the motion-predicted picture 26 and the picture 12, e.g. as described with respect to FIG. 5 (wherein further details of FIG. 5 are optional). According to this embodiment, the feature optimization module 90 comprises a rate-distortion determination block 92 to determine a rate-distortion measure 93 for the features 62. Rate-distortion determination block 92 determines the rate-distortion measure based on a distortion between the picture 12 and the motion-predicted picture 26. For example, the rate-distortion-measure is determined as, or based on, a norm of the residual picture 24, e.g., a sum of absolutes of sample values of the residual picture 24. This option is indicated in FIG. 14 by the dashed arrow with reference sign 24. Alternatively, block 92 may receive the motion-predicted picture 26 and the picture 12 to determine the rate-distortion measure 93. Feature optimization module 90 further comprises an optimization block 95 to optimize the features 62 based on the rate-distortion measure 93 to obtain optimized features 62*.

For example, the optimization may be performed iteratively. For each iteration, encoder 10 may determine the rate-distortion measure for the amended/optimized features resulting from the previous iteration, e.g. by deriving a residual picture as described above (e.g., using the second machine learning predictor to reconstruct motion vectors 71′ based on the features, deriving a motion-predicted picture 26 based on the reconstructed motion vectors 71′ and deriving the residual picture based on the motion-predicted picture 26 and the picture 12).

For example, according to this embodiment, the optimized features 62* may replace features 62 for the subsequent steps. For example, optimized features 62* may replace features 62 as input for blocks 52 and 64 (FIG. 3) and/or block 70 (FIG. 5 and FIG. 7).

According to an embodiment, encoder 10, e.g. by means of feature optimization module 90, optimizes the features 62 using a gradient descent algorithm (e.g. a back tracking line search algorithm, or any other gradient descent algorithm) with respect to the rate-distortion measure.

According to an embodiment, encoder 10, e.g. by means of rate-distortion determination block 92, determines the distortion between the picture 12 and the motion-predicted picture 26 based on the residual picture 24 using a spatial-to-spectral transformation, e.g., a DCT transform, e.g. block-wise, e.g. applied to the distortion (e.g., in the sense of a residuum) between the picture and the motion-predicted picture in units of blocks. E.g., encoder 10 may apply a L1 norm to the transformed residual picture.

In other words, according to an embodiment, the encoder determines, e.g., for each iteration of the optimization, e.g., each iteration of the gradient descent algorithm, a distortion for the rate-distortion measure, with respect to which the features are optimized (e.g. using the gradient descent algorithm), by determining a residual picture based on the features resulting from the previous iteration (or features 62 for the first iteration), subjecting the respective residual picture to a spatial-to-spectral transformation, e.g., a DCT transform such as a DCT-II transform, in units of blocks, and by measuring the residual picture, e.g. by applying a norm such as the L1 norm to the residual picture.

In other words, the distortion between the picture 12 and the predicted picture 26 may represent a residuum between these pictures, and may correlate with a rate for encoding the residual picture into the data stream 14, e.g. using transform coding.

In more general words, according to an embodiment, the encoder may determine a rate measure for the rate-distortion measure based on the residual picture using a spatial-to-spectral transformation, e.g. as described with respect to equation (4) below.

According to an embodiment, encoder 10, e.g. by means of rate-distortion determination block 92, estimates the rate-distortion-measure for the gradient descent algorithm based on a linear approximation for a distortion between the picture 12 and the motion-predicted picture 26, which distortion is associated with a variation of the features, and optionally further based on an estimation for a rate of the features (e.g., the quantized features). In examples, in which the features are entropy coded using probabilities, which are estimated using a hyper encoder and a hyper decoder, the estimation for the rate of the features may further include an estimation of a rate of the hyper parameters.

In particular, in combination with the feature optimization module 90, according to an embodiment, encoder 10 quantizes the features to obtain quantized features 62′, e.g. as described with respect to FIG. 70, see block 66. Further, encoder 10 may encode the quantized features into the data stream 14 using arithmetic encoding, e.g. block 67 of FIG. 7. According to this embodiment, encoder 10 determines the set of reconstructed motion vectors 71′ using the second machine learning predictor 55, e.g. decoding network Dec, based on the quantized features, e.g. as described with respect to FIG. 7. In other words, in the above described derivation of the residual picture may comprise a quantization of the features (features 62, or for further iterations, the features of the previous iteration), and the reconstruction of the motion vectors 71′ may be performed on the quantized features.

As described before, the second machine learning predictor 55 (e.g., and the first machine learning predictor) comprises (or consists of) a convolutional neural network comprising a plurality of linear convolutional layers using rectifying linear units as activation functions. For example, such an implementation of the second machine learning predictor allows an efficient computation of the gradient descent algorithm.

According to an embodiment, the second machine learning predictor 55 has a linear transfer function.

With respect to the first machine learning predictor 61, the optional second machine learning predictor 55, and machine learning predictors 82, 83 of the optional hyper system 80, as well as the optional further machine learning predictor of the motion estimation network 73, described with respect to FIGS. 1 to 14, it is noted that these predictors may comprise trained models, which may be trained end-to-end, e.g. with respect to an optimization of a rate-distortion measure of the reconstructed picture 12′ with respect to the original picture 12, e.g. in view of a specific target rate.

In the following, further embodiments are described making reference to FIG. 12. The reference signs in FIG. 12 provide a relationship between the embodiments described below and the above description of FIGS. 1 to 14. All details, features, and functions described below may be combined with the embodiments described before, e.g. based on the correspondences provided by FIG. 12. It is noted, however, however, that the implementation described below may also be performed without the details described with respect to FIGS. 1 to 14. It is further noted, that advantages described with respect to the implementations described below, also apply to the embodiments described above.

In the following, a concept for deep video coding with gradient-descent optimized motion compensation and Lanczos filtering is described. Embodiments for video encoders/decoders, which may use this concept, or individual aspects thereof, are described above. It is noted that the aspects described in the following section 3.1, 3.2, and 3.3 respectively, may be implemented independently from each other, and, accordingly, may be individually combined with the embodiments described above.

Variational autoencoders have shown promising results for still image compression and have gained a lot of consideration in this field. Recently, noteworthy attempts were made to extend such end-to-end methods to the setting of video compression. Here, low-latency scenarios have been commonly investigated. In this paper, it is shown that the compression efficiency in this setting is improved by applying tools that are typically used in block-based hybrid coding such as rate-distortion optimized encoding of the features and advanced interpolation filters for computing samples at fractional positions. Additionally, a separate motion estimation network is trained to further increase the compression efficiency. Experimental results show that the rate-distortion performance benefits from including the aforementioned tools.

### 1. Introduction

In the following, several approaches to further improve video compression, e.g. for use with autoencoders, are presented. We focus on finding the motion field and representing it as features to efficiently transmit it. Therefore we present a model which consists of, or comprises, a separate network and an autoencoder to first perform a motion estimation and then compress the resulting motion field. The motion field is then applied to the previous frame to get the predicted frame. We show that using a generalized version of interpolation with Lanczos filters instead of bilinear interpolation improves the performance in our setting. Additionally, we use a gradient descent on the features from our motion compression encoder to further improve them and make our model less dependent on the training dataset.

The following description is organized as follows. Section 2 describes the architecture of an autoencoder for motion compensation according to an embodiment. Section 3 presents the aforementioned components and examples for implementing them. Section 4 presents experimental results including ablation studies and the paper concludes with Section 5.

### 2 Description of an Auto-Encoder Architecture

The following setting is given: \hat{x}ᵢ,xᵢ₊₁∈ [symbol] ^{W×H×1} are two consecutive luma-only input pictures from a video sequence where \hat{x}ᵢ is the previously coded and reconstructed reference picture and xᵢ₊₁ is the original picture that we want to transmit. Our framework uses the scale-space flow for the motion, which was introduced by Agustsson et al. in [7].

Here, a scale-space flow field f is used, which has the following mapping

$$f \text{:} {ℝ}^{W \times H} \to {ℝ}^{3} , [ x , y ] ↦ ( {f}_{hor} [ x , y ] , {f}_{ver} [ x , y ] , {f}_{scale} [ x , y ] ) .$$

To apply a motion compensation with f to the image \hat{x}ᵢ, they use a scale-space volume X∈ [symbol] ^{W×H×(M+1)} which consists of the image \hat{x}ᵢ and M blurred versions of \hat{x}ᵢ. Each blurred version is created by convolving \hat{x}ᵢ with a fixed Gaussian kernel Gⱼ, X=[\hat{x}ᵢ,\hat{x}ᵢ*G₀,\hat{x}ᵢ*G₁, . . . , \hat{x}ᵢ*G_{M}] with ascending scale parameters. The motion-compensated image is then calculated for each position [x,y] as

$${x}_{i + 1}^{*} [ x , y ] = X [ x + {f}_{hor} [ x , y ] , y + {f}_{ver} [ x , y ] , {f}_{scale} [ x , y ] ] . \qquad ( 1 )$$

Since X consists of discrete values and f has continuous values, an interpolation has to be used to generate the exact values of x*ᵢ₊₁. Agustsson et al. use trilinear interpolation while we compare that to a more general version. The details are described in 3.1.

Embodiments of the present invention may start by estimating the motion between the two frames with a CNN. Afterwards, an autoencoder framework with hyper priors, e.g., as in [8], may be used, which uses f, x*ᵢ₊₁ and xᵢ₊₁ as inputs for the encoder Enc, that has two main tasks. It tries to find a efficient representation of f as a set of features to efficiently transmit it while also having the possibility to further adapt the motion field.

The resulting features z are then quantized, transmitted with entropy coding, and the motion field is reconstructed with a decoder Dec. Embodiments of the present invention may use a second encoder (e.g., referred to as hyper encoder Enc′) to estimate the parameters for the entropy coding, the details of this framework can be found in FIG. 12.

For example, the motion estimation 91 illustrated in FIG. 12 may represent a motion compensation framework with network architecture. The first network network_{flow} searches a motion field f, which is used as input for the motion compression autoencoder together with the original image xᵢ₊₁ and the pre-searched picture x*ᵢ₊₁, which is the result of applying f to xx. The implementation of Enc, Emc′, Dec, and Dec′ may be as described above with respect to FIG. 12. The black arrows indicate an input for a function or layer, while the dotted arrows denote the motion compensation as described in (1). The correspondences between reference signs in FIG. 12 (also FIG. 11) and the notation in this section is as follows. The picture 12 may be denoted as original frame xᵢ₊₁, the reconstructed previous picture 12′* may be denoted as reference frame \hat{x}ᵢ, the reference picture 76 may be denoted as pre-searched frame x*ᵢ₊₁, the motion-predicted picture 26 may be denoted as predicted picture x̅ᵢ₊₁, the motion-vectors 71 may be denoted as pre-searched motion field f, e.g., comprising fₓ, f_{y}, f_{z} as illustrated in FIG. 12, the reconstructed motion-vectors 71′ may be denoted as final motion field \hat{f}=Dec (\hat{z}), e.g., comprising \hat{f}ₓ, \hat{f}_{y}, \hat{f}_{z} as illustrated in FIG. 12, motion-prediction block 72 may correspond to motion prediction according to equation (1) (note the different inputs of the two occurrences of block 72 in FIG. 12), the first machine learning predictor 61 may correspond to Enc, the second machine learning predictor 55 may correspond to Dec. Hyper encoder 82 may correspond to Enc′, hyper decoder 83 may correspond to Dec′. The probability model 81 may denote a conditional probability model P_{z}(·;(\hat{μ};\hat{σ})). Motion-compensation module 73 may be referred to as network_{flow}. The residual picture 24 may be referred to as residual rᵢ₊₁, the reconstructed residual picture 24′ may be referred to as decoded residual \hat{r}ᵢ₊₁. The reconstructed picture 12′ may be referred to as reconstructed frame \hat{x}ᵢ₊₁. For further correspondences, reference is made to the previous description FIGS. 1 to 14.

For example, the sequence of layers of Enc and Dec may be as follows, using the following notation: Conv M×n×n,s↑ denotes a convolutional layer with output channel size M, kernel size n×n and upsampling with factor s, while s↓ indicates downsampling with factor s: Enc, layers 94 from left to right (input to output): Conv 128×5×5,2↓; Conv 128×5×5,2↓; Conv 128×5×5,2↓; Conv 128×5×5,2↓. Dec, layers 95 from right to left (input to output): Conv 128×5×5,2↑; Conv 128×5×5,2↑; Conv 128×5×5,2↑; Conv 3×5×5,2↑. Activations 97 may be ReLU activations. The sequence of layers of Enc′ and Dec′ may be as follows; Enc′, layers 94 from left to right (input to output): Conv 128×3×3,1↓; Conv 128×5×5,2↓; Conv 128×5×5,2↓. Dec′, layers 95 from right to left (input to output): Conv 128×5×5,2↑; Conv 192×5×5,2↑; Conv 256×3×3,1↑. Activations 97 may be ReLU activations.

In the last step, motion compensation is applied with the reconstructed motion field \hat{f}=(\hat{f}ₕₒᵣ,\hat{f}ᵥₑᵣ,\hat{f}_{scale}) to the reference picture \hat{x}ᵢ, as described in Equation 1 to generate our prediction x̅ᵢ₊₁ for each position [x,y] as follows

$${\overline{x}}_{i + 1} [ x , y ] = X [ x + {\hat{f}}_{hor} [ x , y ] , y + {\hat{f}}_{ver} [ x , y ] , {\hat{f}}_{scale} [ x , y ] ] .$$

An example for the architecture of the first network may be as illustrated in FIG. 11, which may represent a bottleneck architecture of the pre-search network. The first four layers successively decrease the number of neurons and are supposed to find a suitable representation of the original and reference picture in the available feature space. The last four layers then compute the actual motion field. The sequence of layers may be as follows: Layers 94 may be implemented as Conv 512×5×5,2↓, layers 95 may be implemented as Conv 512×5×5,2↑, except for the last one of layers 95 (the most right one in FIG. 11), which may be implemented as Conv 3×5×5,2↑. Activations 97 may be ReLU activations.

The purpose of this network is to perform a distortion-optimized pre-search of the motion vectors and the scale parameters. It may consist of seven convolutional hidden layers with ReLU activations, skip connections, 512 channels and a final output layer. The autoencoder may, e.g., consist of an encoder Enc with 4 convolutional layers with 128 channels, kernel size 5×5, a downsampling stride 2 and ReLU activation in the first 3 layers. The decoder Dec has a similar architecture as Enc, but has an upsampling stride of 2 and a channel size of 3 in the last layer.

The outlined motion compensation process is just a part of the end-to-end video coding. After determining the predicted picture \hat{x}ᵢ₊₁, the residual rᵢ₊₁=xᵢ₊₁−\hat{x}ᵢ₊₁ is calculated and also coded. The decoded residual \hat{r}ᵢ₊₁ is then added to the predicted picture to generate the reconstructed frame \hat{x}ᵢ₊₁=x̅ᵢ₊₁+\hat{r}ᵢ₊₁ Additionally, the I-picture (e.g., an inter-predicted picture) may be encoded separately, e.g. without the described motion framework.

For example, VTM-14.0 [3] may be used to code both the I-picture and the residual as an image. The I-picture is read into our framework and serves as \hat{x}₀. The residual is read and added to the corresponding prediction to generate the reference picture \hat{x}ᵢ₊₁ for the next original picture xᵢ₊₂. Embodiments of the present invention may use, e.g., the intra setting from VTM-14.0 with all in-loop filters such as sample adaptive offset filter, adaptive loop filter and deblocking filter disabled. These filters are applied after adding the prediction and the coded residual, e.g., in VVC, and since the disclosed framework may do this addition outside of VVC, we these enhancements may optionally be disabled to compare results with the same settings.

### Training Details

For example, the training consists of three stages. For example, each training uses stochastic gradient descent with batch size 8 and 2500 batches per epoch. The Adam optimizer [13] is used with step size 10⁻⁴*1.13^{-j} with j=0, . . . , 19 where the step size is decreased if the percentage change from a training epoch falls under a certain threshold. The training steps may employ noisy variables \tilde{z}=z+Δ,\tilde{y}=y+Δ,Δ˜ [symbol] (−0.5,0.5) instead of the quantized values \hat{z} and ŷ.

An exemplary training set consists of 256×256 luma-only patches of the first 180 sequences (in alphabetically order) of the BVI-DVC dataset [10]. The remaining 20 sequences were used as validation set. We used the sequences in class C with resolution 960×544 luma samples. Since the downsampling rates in our autoencoder architecture create hyper priors of size

$$\frac{H}{128} \times \frac{W}{128} \times 128$$

we had to crop the input pictures to 960×512 samples to fit in our framework.

The specifics of an example of the training stages are as follows. First, the pre-search network is trained to minimize the prediction error MSE(xᵢ₊₁,x*ᵢ₊₁). The mean squared error (MSE) between two pictures x*, x∈ [symbol] ^{H×W×1} is defined as

$$MSE ( {x}^{*} , x ) = \frac{1}{WH} {\sum }_{x = 0}^{W - 1} {\sum }_{y = 0}^{H - 1} {( {x}^{*} [ x , y ] - x [ x , y ] )}^{2} . \qquad ( 2 )$$

After this training stage, network_{flow} is fixed.

In the next step the autoencoder network is trained to minimize D_{pred}+λR where D_{pred} is the MSE between x̅ᵢ₊₁ and xᵢ₊₁ and R is the sum of feature bits and hyper prior bits, which is estimated by the sum of entropies of \hat{z} and ŷ, i.e

$$R = {\sum }_{k} - {log}_{2} {P}_{z} ( {\tilde{z}}_{k} , ( {\hat{μ}}_{k} , {\hat{σ}}_{k} ) ) + {\sum }_{l} - {log}_{2} {P}_{y} ( {\tilde{y}}_{l} , ϕ ) , \qquad ( 3 )$$

where k, l denotes the multi-index for \hat{z} respectively ŷ which consists of channel, vertical coordinate and horizontal coordinate of the corresponding latent.

In the last training step, the network is trained with respect to the total rate, which is comprised by the sum of the bitrate of the motion information (3) and the estimated bitrate of the prediction residual. Thus, our loss function for optimizing the network weights is defined as

$${L}_{rate} : \text{=} R + κ {\sum }_{{ℬ}_{j}} {‖ DCT ( {x}_{i + 1} {\vert}_{{ℬ}_{j}} - {\overline{x}}_{i + 1} {\vert}_{{ℬ}_{j}} ) ‖}_{1} . \qquad ( 4 )$$

Here, κ>0 is a scaling factor, ∥⋅∥₁ denotes the l1-norm, { [symbol] }_{j∈J} is the partition of x in 16×16 blocks, [symbol] is the restriction of x to such a block [symbol] and DCT(⋅) denotes the separable DCT-II transform. The second term of (4) aims at simulating the behavior of a block-based transform coder, which is eventually used for coding the residual signal.

For training purposes, the sample positions in the interpolation were rounded to 1/16 fractional positions, thus the Lanczos filters for interpolation can also be determined for 1/16 fractional positions beforehand. This significantly reduces the runtime since the filter coefficients are not re-computed at every position during the training.

### 3 Motion Estimation with Auto-Encoder

The following section gives a short overview over components of embodiments.

### 3.1 Interpolation Filters

To perform motion compensation with a scale space flow field f to an image x, the sample values at non-integer sample positions are interpolated. One possibility is to use trilinear interpolation. However, state-of-the-art video codecs use more general interpolation methods. Therefore it is beneficial to use Lanczos filters [12], which, as many other interpolation filters, are a windowed version of the sinc function. Given the scale a>0 of the kernel size, the Lanczos filter in one dimension is defined as

$$L ( x ) = ( \begin{matrix}sin c ( x ) sin c ( \frac{x}{a} ) & if - a < x < a \\ 0 & otherwise\end{matrix} . \qquad ( 5 )$$

In contrast to bilinear interpolation, which only uses the directly adjacent neighbors to calculate the exact position, Lanczos filters use a bigger neighborhood. In our case, we set the Lanczos parameter a=4, so that 64 neighboring samples in a 8×8-window around the exact position are used. Additionally, each sample has a position between two blurred versions in X, so that 128 samples are used to calculate the new value as the discrete convolution of the volume X with the three-dimensional kernel L(x,y,z)=L(x)L(y)max(0,1−|z|) weighted with the inverse of the sum of all used kernel values.

### 3.2 Pre-Search Network

The pre-search network from Section 2, FIG. 11 (e.g., motion-estimation module 73 of FIG. 10) is used to find an initial motion field between the two input pictures to have a better initialization for the encoder Enc. The motion field f applied to the coded reference frame \hat{x}ᵢ creates the pre-searched picture x*ᵢ₊₁ and is used, e.g. together with f and/or xᵢ₊₁, as encoder input.

For evaluating the impact of the initial motion search, we further optimized a network without the component network_{flow}. Here, the original picture xᵢ₊₁ and the reference picture \hat{x}ᵢ are the only inputs for Enc. Nonetheless, this network is optimized as described in 2.1 without the initial training with respect to (2).

### 3.3 Frame-Wise Rate-Distortion Optimization of the Features

Rate-distortion optimization (RDO) is a important part of modern video codecs. Here, signal-dependant encoder optimizations are made to further improve the performance [16]. According to embodiments, a gradient descent per picture for the features z with respect to the cost (4) is used. The gradient descent can be performed particularly efficiently in embodiment in which the network employs convolutional layers and ReLU activations only.

### 4 Experiments

For evaluating the experiments, the last 20 sequences in alphabetically order of the BVI-DVC dataset were selected. As described in 2.1 we cropped the sequences in the validation set to 960×512 samples. We used VTM-14.0 as a benchmark in the IPPP setting without in-loop filters to compare results in the same setting, as described in 2. Five rate points were tested, where each point has the same QP setting for the I picture (17, 22, 27, 32, or 37) and the P pictures (QP offset 5 to the I picture), regardless of the used method. The results are averaged over the whole sequence length.

We first investigated the impact of the pre-search network on the compression efficiency without using rate-distortion optimization via gradient descent. The pre-search network results in improvements in terms of BjÃ,ntegaard-Delta rate (BD-rate) [9] of −3.17% for high bitrates (4 highest points on the RD-curve) and −4.58% for low bitrates (4 lowest points on the RD-curve) as shown in Table 1. As a result, all ablation studies were done with the pre-search network.

TABLE 1

| Global settings | | | | Without RDO |
|---|---|---|---|---|
| Tool off | Lanczos | Pre-search | RDO per | Pre-search |
| vs. on | filter | network | frame | network |
| Low rates | −22.36% | 2.29% | −22.14% | −4.58% |
| High rates | −23.05% | −0.05% | −15.46% | −3.17% |

Table 1 illustrates experimental results for the a BD-rate. “Global settings” denotes if a tool was turned off for all experiments in this column. “Tool off vs. on” describes which tool was turned off for the ablation study. “Low rates” is computed for the lower four points of the RD-curve and “High rates” for the higher four points.

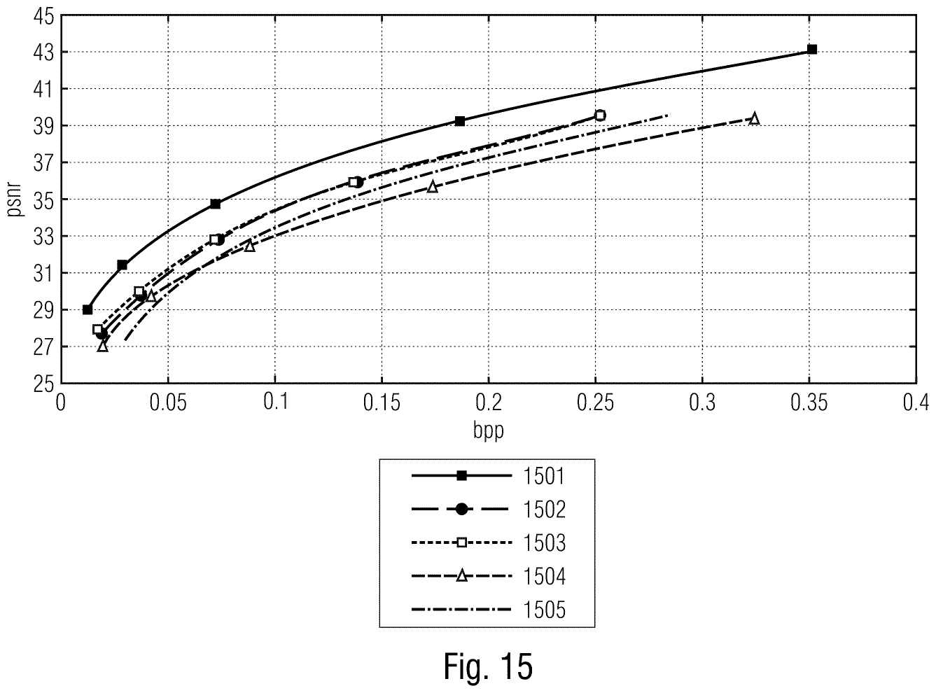

FIG. 15 illustrates experimental RD-results for embodiments in comparison with VTM-14.0. Curve 1501 is the benchmark with VTM-14.0. Curve 1502 shows the results with pre-search network, encoder-side optimization of the features using gradient descent and Lanc-zos interpolation filters. The dashed lines show the differences due to turning off one of these components. Line 1503 is trained without a pre-search model. The BD-rate is 2.29% for low bitrates and −0.05% for high bitrates. This shows, that the frame-wise RDO can improve the model without a pre-search network even more than the model with pre-search network. However, the separate motion estimation is a more generalized version and could easily be replaced by conventional motion estimation methods. Especially when examining sequences with wide-range motion, neural networks can reach their limitations as the search region is limited by the kernel size. Line 1505 shows the results without frame-wise encoder optimizations. The experiments with RDO result in BD-rates of −22.14% for low bitrates and −15.46% for high bitrates. This shows that, especially at low bit rates, the coder can be significantly improved by applying such an encoder optimization. Although the network, according to embodiments, does not calculate the true RD-cost, our estimation seems to be sufficient as shown by the results. Accordingly, embodiments provide a good trade-off between computational effort and RD-cost.

The highest improvement may be achieved by using Lanczos filter instead of bilinear interpolation. The BD-rates are −22.36% for low bitrates and −23.05% for high bitrates. Line 1504 of FIG. 15 shows results without Lanczos filter. The coding gain due to using Lanczos filters increases for higher bit rates. Note that especially for high rates, the quality of the interpolation becomes more crucial. Furthermore, these filters can be easily implemented for arbitrary network architectures.

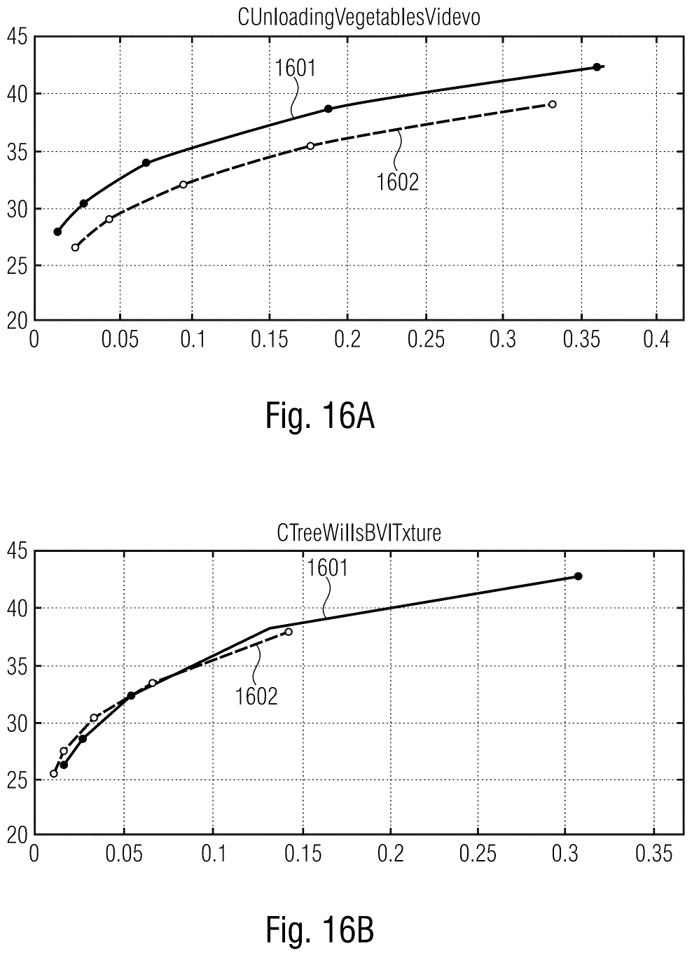

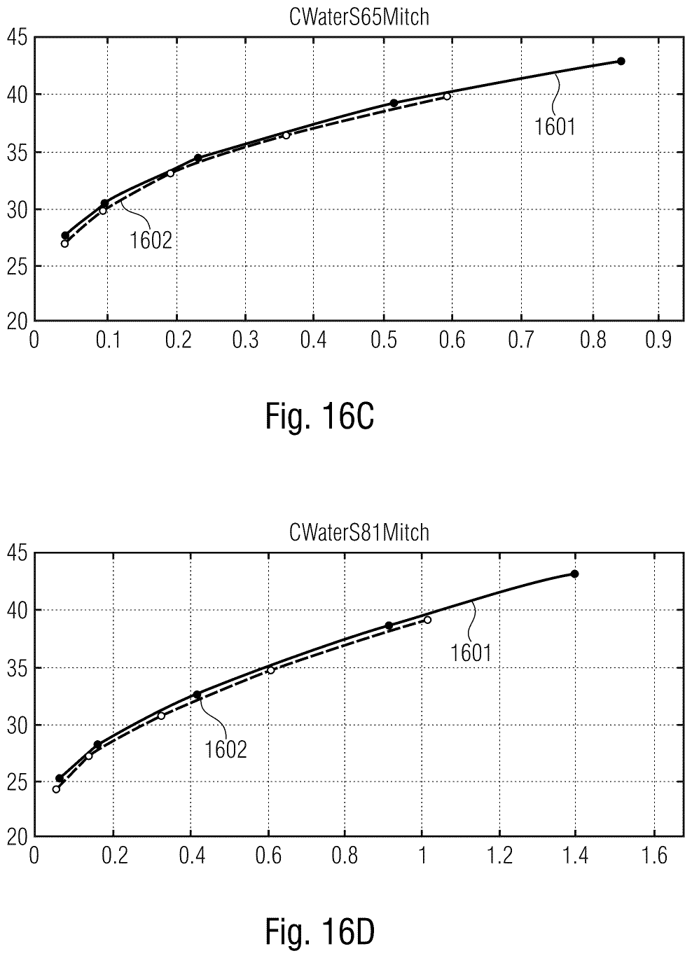

FIG. 16, comprising FIGS. 16A to 16D, illustrates experimental results of embodiments for individual sequences, curves 1601 showing the VTM reference, and curve 1602 showing results of an embodiment. FIG. 16A presents an exemplary sequence with both camera and single object motions. FIG. 16B shows a sequence with a tree in the wind. The leaves move randomly and our coding system exceeds the performance in the range between 0.01 and 0.07 bpp with a BD-rate of −5%. Sequences where motion is much more difficult to predict are shown in FIG. 16C (water movement from above) and FIG. 16D (waves at a beach). Here, our coder also performs closer to VTM-14.0 with BD-rates of 6% and 8% for these two sequences.

In summary, embodiments of the invention may perform particularly well for sequences with small movement, which can be predicted better in a low bit range. Additionally, the model according to embodiments performs well when the motion vectors are difficult to predict, due to the scale parameter.

### 5 Conclusion

Sections 1 to 5 present an exemplary application of aspects of the invention to an autoencoder architecture and demonstrates improvements to an autoencoder based motion compensation by using gradient descent on the encoder side, more complex interpolation filters, and separate motion estimation. Additionally, a framework is disclosed, where pre-searched motion vectors can be used as input while using the advantages of autoencoder based motion compression. Experiments show that Lanczos filtering improves the BD-rate by around-23% and that embodiments can nearly match or exceed the performance of VVC for selected sequences with random movement, that is either small or difficult to predict.

Although sections 1 to 5 describe aspects of the invention in the exemplary context of autoencoder architectures, it is noted that the invention is not limited in this respect, and other embodiments of the invention may use conventional coding techniques, such as transform coding, as described with respect to FIGS. 1 to 14, see in particular FIG. 8 and FIG. 9.

In the following, implementation alternatives for the embodiments described with respect to FIGS. 1 to 14 are described.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In particular, FIGS. 1 to 14 may be regarded as illustration of methods, independent of the described apparatuses, wherein blocks, modules and functions of the described apparatuses shall be regarded as method steps.

Accordingly, FIG. 3 illustrates a method for encoding a picture 12, xᵢ₊₁ (e.g., referred to as the current picture) of a video 11 into a data stream 14 according to an embodiment. The method comprises:
using 60 a first machine learning predictor 61 (e.g. a first neural network, e.g. encoding network Enc, e.g., a downsampling convolutional neural network) to derive a set of features 62, z (e.g., a set of features) representing a motion estimation for the picture with respect to a previous picture 12*, xᵢ (e.g., a picture preceding the current picture according to a coding order among pictures of the video, the coding order indexed with index i. For example, but not necessarily, the previous picture is the directly preceding picture in the coding order. In other examples, there may be further pictures in the coding order between the current and the previous picture, i.e., the current picture may be, relative to the previous picture xᵢ, picture xᵢ₊ₖ, with k a positive number>0; Therefore, the index i+1 used throughout the claims and the description is to be understood a non-limiting illustrative example of the general case using index i+k) of the video,
encoding 64 the set of features into the data stream,
predicting 52 the picture using the set of features to derive a residual picture 24, rᵢ₊₁ (e.g. using the features for obtaining a motion compensated reference picture based on a previous picture of the video; and deriving a residual picture based on the picture and the reference picture), and
encoding 38 the residual picture into the data stream.

Similarly, FIG. 4 illustrates a method for decoding a picture 12′, xᵢ₊₁ of a video 11 from a data stream 14 according to an embodiment. The method comprises:
decoding 65 a set of features 62′ (e.g. quantized features, e.g. a set of features or quantized features) from the data stream, the features representing a motion estimation for the picture with respect to a previous picture 12*′ of the video, decoding 39 a residual picture 24′ from the data stream, and
using 53 a machine learning predictor 55 (e.g. decoding network Dec, e.g., a neural network, e.g. an upsampling convolutional neural network) to reconstruct the picture based on the residual picture using the set of features.

Some or all of the method steps may be executed by (or using) a hardware apparatus, like for example, a microprocessor, a programmable computer or an electronic circuit. In some embodiments, one or more of the most important method steps may be executed by such an apparatus.

The inventive encoded image signal can be stored on a digital storage medium or can be transmitted on a transmission medium such as a wireless transmission medium or a wired transmission medium such as the Internet. In other words, further embodiments provide a video bitstream product including the video bitstream according to any of the herein described embodiments, e.g. a digital storage medium having stored thereon the video bitstream.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

In the foregoing Detailed Description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] B. Bross, J. Chen, J. R. Ohm, G. J. Sullivan, and Y. K. Wang, “Developments in International Video Coding Standardization After AVC, With an Overview of Versatile Video Coding (VVC),” Proceedings of the IEEE, pp. 1-31, 2021.
[2] “Versatile Video Coding,” ITU-T Rec. H.266 and ISO/IEC 23090-3, 2020.
[3] M. Wien and B. Bross, “Versatile Video Coding—Algorithms and Specification,” in 2020 IEEE International Conference on Visual Communications and Image Processing (VCIP), 2020, pp. 1-3.
[4] Wei-Jung Chien, Li Zhang, Martin Winken, Xiang Li, Ru-Ling Liao, Han Gao, Chih-Wei Hsu, Hongbin Liu, and Chun-Chi Chen, “Motion vector coding and block merging in the versatile video coding standard,” IEEE Transactions on Circuits and Systems for Video Technology, vol. 31, no. 10, pp. 3848-3861, 2021.
[5] Haitao Yang, Huanbang Chen, Jianle Chen, Semih Esenlik, Sriram Sethuraman, Xiaoyu Xiu, Elena Alshina, and Jiancong Luo, “Subblock-based motion derivation and inter prediction refinement in the versatile video coding standard,” IEEE Transactions on Circuits and Systems for Video Technology, vol. 31, no. 10, pp. 3862-3877, 2021.
[6] Jiaying Liu, Sifeng Xia, Wenhan Yang, Mading Li, and Dong Liu, “One-for-all: Grouped variation network-based fractional interpolation in video coding,” IEEE Transactions on Image Processing, vol. 28, no. 5, pp. 2140-2151, 2018.
[7] J. Balle′, V. Laparra, and E. P. Simoncelli, “End-to-end optimized image compression,” in International Conference on Learning Representations (ICLR), Toulon, France, April 2017.
[8] David Minnen, Johannes Ballé, and George D. Toderici, “Joint Autore-gressive and Hierarchical Priors for Learned Image Compression,” in Advances in Neural Information Processing Systems, S. Bengio, H. Wal-lach, H. Larochelle, K. Grauman, N. Cesa-Bianchi, and R. Garnett, Eds. 2018, vol. 31, pp. 10771-10780, Curran Associates, Inc.
[9] Johannes Balle, David Minnen, Saurabh Singh, Sung Jin Hwang, and Nick Johnston, “Variational image compression with a scale hyperprior,” in International Conference on Learning Representations, 2018.
[10] Guo Lu, Wanli Ouyang, Dong Xu, Xiaoyun Zhang, Chunlei Cai, and Zhiyong Gao, “Dvc: An end-to-end deep video compression framework,” in Proceedings of the IEEE/CVF Conference on Computer Vision and Pattern Recognition, 2019, pp. 11006-11015.
[11] Eirikur Agustsson, David Minnen, Nick Johnston, Johannes Balle, Sung Jin Hwang, and George Toderici, “Scale-space flow for end-to-end optimized video compression,” in Proceedings of the IEEE/CVF Conference on Computer Vision and Pattern Recognition, 2020, pp. 8503-8512.
[12] M Akin Yilmaz and A Murat Tekalp, “End-to-end rate-distortion optimized learned hierarchical bi-directional video compression,” IEEE Transactions on Image Processing, vol. 31, pp. 974-983, 2021.
[13] M Akin Yilmaz and A Murat Tekalp, “End-to-end rate-distortion optimization for bi-directional learned video compression,” in 2020 IEEE International Conference on Image Processing (ICIP). IEEE, 2020, pp. 1311-1315.
[14] A. Browne, J. Chen, Y. Ye, and S. Kim, “Algorithm description for Versatile Video Coding and Test Model 14 (VTM 14),” JVET-T2002, Joint Video Experts Team (JVET), July 2021.
[15] Diederik P. Kingma and Jimmy Ba, “Adam: A Method for Stochastic Optimization,” in 3rd International Conference on Learning Representations, ICLR 2015, San Diego, CA, USA, May 7-9, 2015, Conference Track Proceedings, Yoshua Bengio and Yann LeCun, Eds., 2015.
[16] Di Ma, Fan Zhang, and David Bull, “Bvi-dvc: A training database for deep video compression,” IEEE Transactions on Multimedia, 2021.
[17] Claude E Duchon, “Lanczos filtering in one and two dimensions,” Journal of Applied Meteorology and Climatology, vol. 18, no. 8, pp. 1016-1022, 1979.
[18] Gary J Sullivan and Thomas Wiegand, “Rate-distortion optimization for video compression,” IEEE signal processing magazine, vol. 15, no. 6, pp. 74-90, 1998.
[19] Gisle Bjontegaard, “Calculation of average psnr differences between rd-curves,” VCEG-M33, 2001

1. An apparatus for encoding a picture of a video into a data stream, configured for
using a first machine learning predictor to derive a set of features representing a motion estimation for the picture with respect to a previous picture of the video,
encoding the set of features into the data stream,
predicting the picture using the set of features to derive a residual picture by
determining a set of reconstructed motion vectors based on the features,
deriving a motion-predicted picture based on a reconstructed previous picture using the set of reconstructed motion vectors, and
deriving the residual picture based on the picture and the motion-predicted picture, and
encoding the residual picture into the data stream,
wherein the reconstructed motion vectors represent vectors in a motion space, the motion space being defined by a plurality of pictures comprising the previous picture and a set of filtered versions of the previous picture.

2. The apparatus according to claim 1, configured for
deriving a set of motion vectors based on the picture and the previous picture using a motion estimation network, the motion estimation network comprising a machine learning predictor,
wherein the first machine learning predictor is configured for deriving the features based on the set of motion vectors, wherein the apparatus is configured for deriving a reference picture based on a reconstructed previous picture using the set of motion vectors,
wherein the first machine learning predictor is configured for receiving, as an input, one or more or all of the picture, the reference picture, and the set of motion vectors.

3. The apparatus for encoding a picture of a video into a data stream, configured for
using a first machine learning predictor to derive a set of features representing a motion estimation for the picture with respect to a previous picture of the video,
encoding the set of features into the data stream,
predicting the picture using the set of features to derive a residual picture, by
using a second machine learning predictor to determine a set of reconstructed motion vectors based on the features,
deriving a motion-predicted picture based on the previous picture using the set of reconstructed motion vectors, and
deriving the residual picture based on the motion-predicted picture and the picture, and
encoding the residual picture into the data stream,
wherein the apparatus is configured for optimizing the features with respect to a rate-distortion measure for the features, the rate-distortion measure being determined based on a distortion between the picture and the motion-predicted picture.

4. The apparatus according to claim 3, configured for
quantizing the features to acquire quantized features, and
determining the set of reconstructed motion vectors using the second machine learning predictor based on the quantized features.

5. The apparatus according to claim 3, configured for
optimizing the features using a gradient descent algorithm with respect to the rate-distortion measure.

6. The apparatus according to claim 3, configured for
determining a rate measure for the rate-distortion measure based on the residual picture using a spatial-to-spectral transformation, and/or
determining the distortion between the picture and the motion-predicted picture based on the residual picture using a spatial-to-spectral transformation.

7. The apparatus according to claim 3,
wherein the second machine learning predictor comprises a convolutional neural network comprising a plurality of linear convolutional layers using rectifying linear units as activation functions, and/or
wherein the second machine learning predictor comprises a linear transfer function.

8. An apparatus for decoding a picture of a video from a data stream, configured for
decoding a set of features from the data stream, the set of features representing a motion estimation for the picture with respect to a previous picture of the video,
decoding a residual picture from the data stream, and
using a machine learning predictor to determine a set of reconstructed motion vectors based on the features, and
reconstructing the picture based on the residual picture using the set of reconstructed motion vectors,
wherein the reconstructed motion vectors represent vectors in a motion space, the motion space being defined by a plurality of pictures comprising the previous picture and a set of filtered versions of the previous picture.

9. The apparatus according to claim 8, configured for
decoding the residual picture using block-based transform coding, and/or
intra-predicting a block of the residual picture based on a previous block of the residual picture.

10. The apparatus according to claim 8,
configured for decoding the features from the data stream using entropy decoding,
wherein the apparatus is configured for determining a probability model for the entropy decoding by
decoding a set of hyper parameters from the data stream,
subjecting the hyper parameters to a further machine learning predictor.

11. The apparatus according to claim 8, configured for
deriving a motion-predicted picture based on a reconstructed previous picture using the set of reconstructed motion vectors, and
reconstructing the picture based on the residual picture and the motion-predicted picture.

12. The apparatus according to claim 8,
wherein the set of reconstructed motion vectors comprises, for each of a plurality of samples of the motion-predicted picture, a corresponding reconstructed motion vector, and
wherein the apparatus is configured for deriving a sample of the motion-predicted picture by weighting a set of samples of the motion space, the samples of the set of samples being positioned within a region of the motion space, which region is indicated by the corresponding reconstructed motion vector of the of the motion-predicted picture.

13. The apparatus according to claim 8,
wherein the set of reconstructed motion vectors comprises, for each of a plurality of samples of the motion-predicted picture, a corresponding reconstructed motion vector, and
wherein the apparatus is configured for deriving a sample of the motion-predicted picture by weighting a set of samples of the motion space, the samples of the set of samples being positioned within a region of the motion space, which region is indicated by the corresponding reconstructed motion vector of the of the motion-predicted picture,
wherein the apparatus is configured for weighting the samples of the set of samples using one or more Lanczos filters.

14. The apparatus according to claim 13,
wherein the motion space is spanned in a first dimension and a second dimension by first and second dimensions of 2D sample arrays of the pictures, and in a third dimension by an order among the plurality of pictures,
wherein the apparatus is configured for acquiring a weight for one of the samples of the set of samples using a first Lanczos filter for the first dimension of the motion space, and a second Lanczos filter for the second dimension of the motion space.

15. The apparatus according to claim 13,
wherein each of the one or more Lanczos filters is represented by a windowed sinc filter.

16. The apparatus according claim 15, configured for
evaluating the Lanczos filters with a precision of ¼, or ⅛, or 1/16, or 1/32 of a sample position precision of the motion space, and/or
evaluating the Lanczos filters using a distance between a sample position of the sample and a position indicated by the corresponding reconstructed motion vector, wherein the apparatus is configured for determining the distance with a precision of ¼, or ⅛, or 1/16, or 1/32 of a sample position precision of the motion space.

17. A method for encoding a picture of a video into a data stream, comprising:
using a first machine learning predictor to derive a set of features representing a motion estimation for the picture with respect to a previous picture of the video,
encoding the set of features into the data stream,
predicting the picture using the set of features to derive a residual picture by
determining a set of reconstructed motion vectors based on the features,
deriving a motion-predicted picture based on a reconstructed previous picture using the set of reconstructed motion vectors, and
deriving the residual picture based on the picture and the motion-predicted picture, and
encoding the residual picture into the data stream,
wherein the reconstructed motion vectors represent vectors in a motion space, the motion space being defined by a plurality of pictures comprising the previous picture and a set of filtered versions of the previous picture.

18. A Method for encoding a picture of a video into a data stream, the method comprising:
using a first machine learning predictor to derive a set of features representing a motion estimation for the picture with respect to a previous picture of the video,
encoding the set of features into the data stream,
predicting the picture using the set of features to derive a residual picture, by
using a second machine learning predictor to determine a set of reconstructed motion vectors based on the features,
deriving a motion-predicted picture based on the previous picture using the set of reconstructed motion vectors, and
deriving the residual picture based on the motion-predicted picture and the picture, and
encoding the residual picture into the data stream,
wherein the method comprise optimizing the features with respect to a rate-distortion measure for the features, the rate-distortion measure being determined based on a distortion between the picture and the motion-predicted picture.

19. A Method for decoding a picture of a video from a data stream, comprising:
decoding a set of features from the data stream, the features representing a motion estimation for the picture with respect to a previous picture of the video,
decoding a residual picture from the data stream, and
using a machine learning predictor to determine a set of reconstructed motion vectors based on the features, and
reconstructing the picture based on the residual picture using the set of reconstructed motion vectors,
wherein the reconstructed motion vectors represent vectors in a motion space, the motion space being defined by a plurality of pictures comprising the previous picture and a set of filtered versions of the previous pictures.
